(19) United States
(12) Patent Application Publication
(10) Pub. No.: US 2026/0189668 A1
(43) Pub. Date: Jul. 2, 2026

(54) IMAGE PROCESSING APPARATUS AND METHOD

(71) Applicant: CANON KABUSHIKI KAISHA, Tokyo (JP)

(72) Inventors: SHINICHI MIYAZAKI, Kanagawa (JP); AKITOSHI YAMADA, Kanagawa (JP); HISASHI ISHIKAWA, Chiba (JP); FUMINO MATSUI, Kanagawa (JP)

(21) Appl. No.: 19/426,385

(22) Filed: Dec. 19, 2025

(30) Foreign Application Priority Data
Dec. 26, 2024 (JP) 2024-231017
Dec. 26, 2024 (JP) 2024-231018

(51) Int. Cl. H04N 1/60

(52) U.S. Cl. CPC H04N 1/6066; H04N 1/6027

(57) ABSTRACT

An image processing apparatus includes: an input unit that inputs image data; and a first color conversion unit that executes, in a case where an image represented by the image data input by the input unit includes a gradation region including gradation between a first color value and a second color value and a region other than the gradation region in the image includes a first solid region with only the first color value and a second solid region with only the second color value, color conversion for the first solid region and the second solid region by a first color conversion method and color conversion for the gradation region by a second color conversion method.

### BACKGROUND

### Field of the Technology

The present disclosure relates to an image processing apparatus capable of executing gamut mapping, and a method.

### Description of the Related Art

There is known a printer that receives a digital original described in a predetermined color space, performs, for each color in the color space, mapping to a color reproduction region that can be reproduced by the printer, and outputs the original. There is known, for example, a method of identifying an object in an original, performing “colorimetric” mapping for a graphic region, and performing “perceptual” mapping for a photo region. However, it is very difficult to identify an object, and especially in a case where a plurality of objects overlap each other, one of the above mapping processes is selected for an object with regions merged.

Japanese Patent Laid-Open No. 2023-60805 describes that original data to be printed is analyzed and is divided into a plurality of partial original data. Then, it is described that based on pixel values included in a partial original for each partial original data and a color reproduction region (color gamut) at the time of printing, a color mapping method (color conversion method) to a color reproduction region that can be reproduced by a printer is set for the partial original to perform color conversion.

### SUMMARY

There is a need to improve the color reproducibility of the solid region while reproducing the tonality of the gradation region when image data including a gradation region and a solid region is input.

The present disclosure provides an image processing apparatus that implements appropriate color reproduction in a printed product obtained by printing image data, and a method.

The present disclosure in one aspect provides an image processing apparatus comprising: an input unit configured to input image data; and a first color conversion unit configured to execute, in a case where an image represented by the image data input by the input unit includes a gradation region including gradation between a first color value and a second color value and a region other than the gradation region in the image includes a first solid region with only the first color value and a second solid region with only the second color value, color conversion for the first solid region and the second solid region by a first color conversion method and color conversion for the gradation region by a second color conversion method, wherein the color conversion by the first color conversion unit is conversion from a color gamut represented by the image data into a color gamut that can be reproduced by the image processing apparatus, and as a result of executing the color conversion by the first color conversion unit, a color difference between the first solid region and the second solid region is larger than a color difference between a region corresponding to the first color value and a region corresponding to the second color value in the gradation region.

According to the present disclosure, it is possible to implement appropriate color reproduction in a printed product obtained by printing image data.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing the configuration of an image processing apparatus;

FIG. 2 is a view for explaining a printhead;

FIG. 3 is a flowchart illustrating processing in the image processing apparatus;

FIGS. 4A and 4B are views for explaining partial original data;

FIG. 5 is a flowchart illustrating processing in the image processing apparatus;

FIG. 6 is a view showing input image data;

FIG. 7 is a view for explaining color degeneration and its correction;

FIGS. 8A and 8B are views for explaining setting processing of a second region;

FIG. 9 is a view showing the second region;

FIG. 10 is a flowchart illustrating processing in the image processing apparatus;

FIGS. 11A and 11B are views each showing a print result;

FIG. 12 is a flowchart illustrating processing in an image processing apparatus;

FIG. 13 is a view showing input image data;

FIGS. 14A and 14B are views for explaining color degeneration and its correction;

FIGS. 15A and 15B are views showing a third region;

FIGS. 16A and 16B are views showing a first region, the second region, and the third region;

FIGS. 17A and 17B are views each showing a print result;

FIG. 18 is a view showing a user interface screen;

FIG. 19 is a view showing a user interface screen;

FIGS. 20A to 20D are views for explaining a color conversion method;

FIGS. 21A to 21C are views for explaining a color conversion method;

FIGS. 22A to 22C are views for explaining a color conversion method;

FIG. 23 is a view showing input image data;

FIG. 24 is a view for explaining a decrease in chroma and its correction;

FIG. 25 is a flowchart illustrating processing in an image processing apparatus;

FIGS. 26A and 26B are views each showing a print result;

FIG. 27 is a view showing input image data;

FIGS. 28A and 28B are views for explaining a decrease in chroma and its correction;

FIGS. 29A and 29B are views showing the third region;

FIGS. 30A and 30B are views each showing a print result;

FIGS. 31A to 31C are views for explaining a color conversion method; and

FIG. 32 is a view for explaining a color conversion method.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

### First Embodiment

There is a need to improve the color reproduction of discriminability of the solid region while reproducing the tonality of the gradation region when image data including a gradation region and a solid region is input.

Terms used in this embodiment are defined in advance, as follows.

### (Color Reproduction Region)

A color reproduction region indicates the range of colors that can be reproduced in an arbitrary color space. The color reproduction region is also called a color reproduction range, a color gamut, or a gamut. A gamut volume is an index representing the extent of this color reproduction region. The gamut volume is a three-dimensional volume in an arbitrary color space. Chromaticity points forming the color reproduction region are sometimes discrete. For example, a specific color reproduction region is represented by 729 points on CIE-L*a*b*, and points between them are obtained by using a well-known interpolating operation such as tetrahedral interpolation or cubic interpolation. In this case, as the corresponding gamut volume, it is possible to use a volume obtained by calculating the volumes on CIE-L*a*b* of tetrahedrons or cubes forming the color reproduction region and accumulating the calculated volumes, in accordance with the interpolating operation method. The color reproduction region and the color gamut in this embodiment are not limited to a specific color space. In this embodiment, however, a color reproduction region in the CIE-L*a*b* space will be explained as an example. Similarly, the numerical value of a color reproduction region in this embodiment indicates a volume obtained by accumulation in the CIE-L*a*b* space on the premise of tetrahedral interpolation.

### (Gamut Mapping)

Gamut mapping is conversion processing between different color gamuts. For example, gamut mapping is mapping of an input color gamut to an output color gamut. Conversion in the same color gamut is not called gamut mapping.

Perceptual/Saturation/Colorimetric, and the like of the International Color Consortium (ICC) profile are commonly used. In the mapping processing, for example, conversion may be performed using one 3D Look Up Table (LUT). Furthermore, the mapping processing may be performed after conversion of a color space into a standard color space. For example, if an input color space is sRGB, conversion into the CIE-L*a*b* color space is performed. The mapping processing to an output color gamut is performed on the CIE-L*a*b* color space. The mapping processing may be 3D LUT processing or processing using a conversion formula. Conversion between the input color space and the output color space may be performed simultaneously. For example, the input color space may be the sRGB color space, and conversion into RGB values or CMYK values unique to a printing apparatus may be performed at the time of output.

### (Color Degeneration)

In this embodiment, the fact that when performing gamut mapping for two arbitrary colors, the distance between the colors after mapping in a predetermined color space is smaller than the distance between the colors before mapping is defined as color degeneration. More specifically, assume that there are a color A and a color B in a digital original, and mapping to the color gamut of a printer is performed to convert the color A into a color C and the color B into a color D. In this case, the fact that the distance between the colors C and D is smaller than the distance between the colors A and B is defined as color degeneration. If color degeneration occurs, colors that are recognized as different colors in the digital original are recognized as identical colors when the image is printed. For example, in a graph, different items are recognized as different items by different colors. When color degeneration occurs, different colors may be recognized as identical colors and thus the different items in the graph may erroneously be recognized as identical items (discriminability may decrease). The predetermined color space in which the distance between the colors is calculated may be an arbitrary color space. Examples of the color space are the sRGB color space, the Adobe RGB color space, the CIE-L*a*b* color space, the CIE-LUV color space, the XYZ color space, the xyY color space, the HSV color space, and the HLS color space.

### <Entire Image Processing Apparatus>

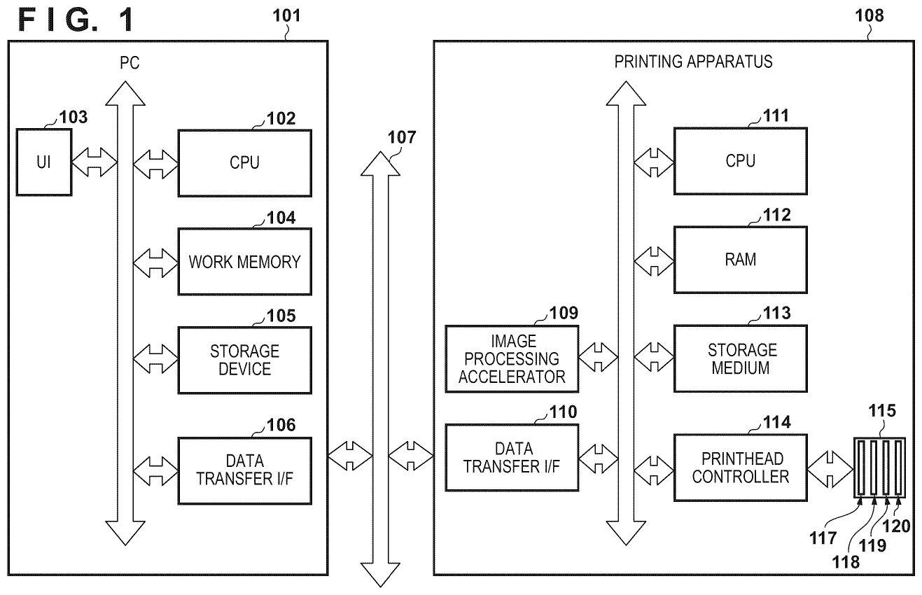

FIG. 1 shows the overall configuration of a print system to which an image processing apparatus according to this embodiment is applied. The system includes a personal computer (PC) 101 (to be also referred to as a “PC” hereinafter) and a printing apparatus 108. The PC 101 sends a printing control instruction to the printing apparatus 108, and transfers necessary information and data. An OS as well as a system program, various application software programs, and parameter data necessary for various processes are stored and managed in a storage device 105. As the storage device 105, a hard disk, a flash ROM, or the like is used. A CPU 102 executes processing using a work memory 104 when executing software stored in the storage device 105. An operation unit (to also be referred to as a “UI” hereinafter) 103 serving as a user interface performs processing associated with user input or display to a user with respect to execution of the above-described processing, and includes an input device such as a keyboard and a mouse and a display device such as a display. A data transfer I/F 106 performs data input/output from/to an external storage medium such as an SD card. An image capturing apparatus (not shown) may be directly connected to the data transfer I/F 106 or a data transfer I/F 110 to transfer data without intervention of an external storage medium.

The PC 101 and the printing apparatus 108 are connected via a communication line 107. In this embodiment, a local area network will be described as an example of the communication line 107, but a wireless communication network using a USB hub or a wireless access point, connection using a Wi-Fi® direct communication function, or the like may be adopted.

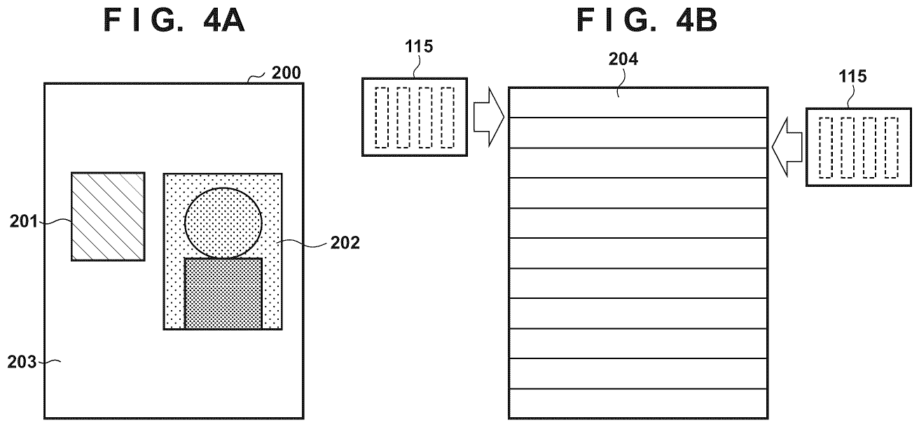

Original data to be printed, which is transferred to the printing apparatus 108, is in, for example, a Portable Document Format (PDF) or a PWG-Raster format. PWG-Raster is a data format standardized by Printer Working Group (PWG). In this embodiment, the PWG-Raster format is used. Original data or image data included in original data stores bitmap data in accordance with a data format, and includes no pixel-based type information (information indicating the attribute of a pixel (for example, information such as a character, a photo, or a line)). This embodiment will describe an example of the PWG-Raster format but the present disclosure is not limited to this. It suffices any image data including no type information. For example, image data in the PDF may be described in Joint Photographic Experts Group (JPEG) data including no pixel-based type information. Image data need only be image data, at least a part of which includes no type information. As shown in FIG. 4A to be described later, in a case where image data is described in a Page Description Language (PDL), a region 201 or 202 as a region unit decided by a drawing command may be added with an attribute such as a character or an image at the time of rendering. However, a region may not be divided into the regions 201 and 202, and an entire page 200 may be regarded as one JPEG image, and formed as a PDF file. In this case, an individual attribute such as a line for the region 201 or a photo for the region 202 is not added. Therefore, as described above, if the entire page or, for example, only the region 201 is a region of image data including no type information like a JPEG image, this embodiment can be applied to the region. This embodiment will describe an example in which entire image data includes no type information. However, if image data includes at least a partial region that includes no type information, this embodiment may be applied only to that region.

The printing apparatus 108 interprets original data sent from the PC 101, and executes image processing on generated image data. In the printing apparatus 108, a CPU 111 reads out a program stored in a storage medium 113 to a RAM 112 as a work area and executes the readout program, thereby comprehensively controlling the printing apparatus 108. An image processing accelerator 109 is hardware capable of executing image processing faster than the CPU 111. The image processing accelerator 109 is activated when the CPU 111 writes a parameter and data necessary for image processing at a predetermined address of the RAM 112. The image processing accelerator 109 loads the above-described parameter and data, and then executes the image processing on the data. Note that the image processing accelerator 109 is not an essential element, and the CPU 111 may execute equivalent processing. The above-described parameter can be stored in the storage medium 113, or can be stored in a storage (not shown) such as a flash memory or an HDD.

The image processing to be performed by the CPU 111 or the image processing accelerator 109 will now be explained. This image processing is, for example, processing of generating, based on acquired original data, data indicating the dot formation position of ink in each scan by a printhead 115. The CPU 111 or the image processing accelerator 109 performs, for example, color separation processing and quantization processing on the image data.

The color separation processing is processing of performing color separation to ink densities to be handled in the printing apparatus 108. For example, in a case where the image data is data indicating an image in a color space coordinate system such as sRGB as the expression colors of a monitor, data indicating an image by color coordinates (R, G, B) of the sRGB is converted into ink data to be handled by the printing apparatus 108 by performing the color separation processing. The color conversion method is implemented by, for example, matrix operation processing or processing using a three-dimensional look up table (3D LUT) or 4D LUT.

As an example, the printing apparatus 108 according to this embodiment uses inks of black (K), cyan (C), magenta (M), and yellow (Y). Therefore, image data of RGB signals is converted into ink data (print data) formed by 8-bit color signals of K, C, M, and Y. The color signal of each color corresponds to the application amount of each ink. Furthermore, the ink colors are four colors of K, C, M, and Y, as examples. However, to improve image quality, other ink colors such as inks of light cyan (Lc), light magenta (Lm), and gray (Gy) having low densities may be used. In this case, ink data corresponding to the inks are generated.

After the color conversion processing, quantization processing is performed for the ink data. This quantization processing is processing of decreasing the number of tone levels of the ink data. In this embodiment, quantization is performed by using a dither matrix in which thresholds to be compared with the values of the ink data are arrayed in individual pixels. After the quantization processing, binary data indicating whether to form a dot in each dot formation position is finally generated.

After the image processing is performed, a printhead controller 114 transfers the binary data to the printhead 115. At the same time, the CPU 111 performs printing control via the printhead controller 114 so as to operate a carriage motor for operating the printhead 115, and to operate a conveyance motor for conveying a print medium. The printhead 115 scans the print medium and also discharges ink droplets onto the print medium, thereby printing an image.

A description will be provided below by assuming that the printhead 115 has print nozzle arrays for four color inks of cyan (C), magenta (M), yellow (Y), and black (K).

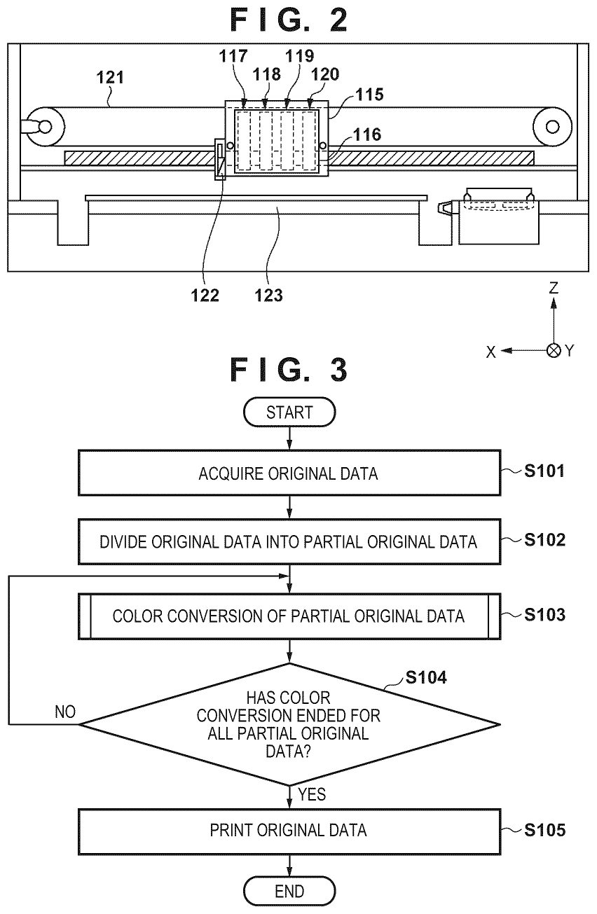

FIG. 2 is a view for explaining the printhead 115 according to this embodiment. In this embodiment, an image is printed on a unit area for one nozzle array by N scans. The printhead 115 includes a carriage 116, nozzle arrays 117, 118, 119, and 120, and an optical sensor 122. The carriage 116 on which the four nozzle arrays 117, 118, 119, and 120 and the optical sensor 122 are mounted can reciprocally move along a main scan direction (the X direction in FIG. 2) by the driving force of a carriage motor transmitted via a belt 121. While the carriage 116 moves in the X direction relative to a print medium, ink droplets are discharged from each nozzle of the nozzle arrays in the gravity direction (the −Z direction in FIG. 2) based on print data. In this embodiment, a discharge element that discharges an ink droplet from each nozzle employs a thermal method of discharging a liquid by causing an electrothermal transducer to generate bubbles. However, the present disclosure is not limited to this, and a discharge element that employs a method of discharging a liquid using a piezoelectric element or another discharge method may be used.

Consequently, an image corresponding to 1/N (N: natural number) of a main scan is printed on the print medium placed on a platen 123. Upon completion of one main scan, the print medium is conveyed along a conveyance direction (the −Y direction in FIG. 2) crossing the main scan direction by a distance corresponding to the width of 1/N of the main scan. These operations print an image in an area having the width of one nozzle array by N scans. An image is gradually printed on the print medium by alternately repeating the main scan and the conveyance operation, as described above. In this way, control can be executed to complete image printing in a predetermined area.

### <Print Processing>

FIG. 3 is a flowchart illustrating print processing in the printing apparatus 108. The processing shown in FIG. 3 is implemented when, for example, the CPU 111 executes a program read out to the RAM 112.

In step S101, the CPU 111 acquires original data to be printed. More specifically, for example, the CPU 111 acquires original data from the data transfer I/F 106 of the PC via the data transfer I/F 110 of the printing apparatus 108. Assume that the original data is document data formed from a plurality of pages.

Next, in step S102, the CPU 111 divides the original data into a plurality of partial original data. In this embodiment, the original data to be printed is, for example, document data formed from a plurality of pages. The partial original data may be in any format as long as it is a processing unit obtained by dividing the original data. FIGS. 4A and 4B are views for explaining the partial original data. For example, a page unit may be set as the partial original data like the page 200 shown in FIG. 4A. FIG. 4B shows a print region printed by the scan of the printhead 115. A region 204 shows an example in which printing is completed by two scans (an arrow indicates the scan direction) of the printhead 115. Unit data printed by the printhead, like the region 204, may be set as the partial original data. Furthermore, if the image data shown in FIG. 4A is described in the PDL as a page description language, the region 201 or 202 as a region unit decided by a drawing command may be set as the partial original data. For, for example, a page unit, a plurality of region units decided by a page, a band, or a drawing command may be combined to generate one partial original data like in a case where the first page and the second page are combined to generate one partial original data. This embodiment shows an example of dividing original data into partial original data on a page basis.

Next, in step S103, the CPU 111 executes loop processing for each partial original data. In step S103, the CPU 111 performs color conversion processing on the partial original data. Details of the color conversion processing will be described later.

Next, in step S104, the CPU 111 determines whether color conversion has ended for all the partial original data. If it is determined that color conversion has ended, the process advances to step S105. If it is determined that color conversion has not ended, the color conversion processing of step S103 is executed for the next partial original data. Next, in step S105, the CPU 111 prints the original data. More specifically, for example, four processes of ink color separation, output characteristic conversion, quantization, and printing are performed for each pixel of the image data converted in step S103.

Ink color separation is processing of converting output values Rout, Gout, and Bout of the color conversion processing into output values of ink colors used to print by an inkjet printing method. This embodiment assumes, for example, printing by four color inks of cyan, magenta, yellow, and black. There are various methods of implementing this conversion processing. For example, similar to the color conversion processing, the three-dimensional LUT is used to calculate a combination of preferable ink color pixel values (C, M, Y, K) with respect to a combination of the output pixel values (Rout, Gout, Bout). For example, a three-dimensional LUT2 [256] [256] [256] [4] as follows is used.

$$C = LUT 2 [ Rout ] [ Gout ] [ Bout ] [ 0 ] \qquad ( 1 )$$

$$M = LUT 2 [ Rout ] [ Gout ] [ Bout ] [ 1 ] \qquad ( 2 )$$

$$Y = LUT 2 [ Rout ] [ Gout ] [ Bout ] [ 2 ] \qquad ( 3 )$$

$$K = LUT 2 [ Rout ] [ Gout ] [ Bout ] [ 3 ] \qquad ( 4 )$$

The table size may be reduced by decreasing the number of grids of the LUT from 256 grids to, for example, 16 grids and deciding output values by interpolating table values of a plurality of grids.

Next, output characteristic conversion is processing of converting the density of each ink color into a print dot ratio. More specifically, for example, the densities of colors each having 256 tones are converted into print dot ratios Cout, Mout, Yout, and Kout in 1024 tones for each color. For this purpose, for example, a one-dimensional LUT3 [4] [256] as follows in which a preferable print dot ratio is set in correspondence with the density of each ink color is used.

$$Cout = LUT 3 [ 0 ] [ C ] \qquad ( 5 )$$

$$Mout = LUT 3 [ 1 ] [ M ] \qquad ( 6 )$$

$$Yout = LUT 3 [ 2 ] [ Y ] \qquad ( 7 )$$

$$Kout = LUT 3 [ 3 ] [ K ] \qquad ( 8 )$$

The table size may be reduced by decreasing the number of grids of the LUT from 256 grids to, for example, 16 grids and deciding output values by interpolating table values of a plurality of grids.

Next, quantization is processing of converting the print dot ratios Cout, Mout, Yout, and Kout of the ink colors into On/Off of the print dot of each actual pixel. As the method of quantization, various methods, for example, an error diffusion method and a dither method can be used. For example, by the dither method, the quantization is implemented by the following equations.

$$Cdot = Halftone [ Cout ] [ x ] [ y ] \qquad ( 9 )$$

$$Mdot = Halftone [ Mout ] [ x ] [ y ] \qquad ( 10 )$$

$$Ydot = Halftone [ Yout ] [ x ] [ y ] \qquad ( 11 )$$

$$Kdot = Halftone [ Kout ] [ x ] [ y ] \qquad ( 12 )$$

The values are compared with a threshold according to each pixel position (x, y), thereby implementing On/Off of the print dot of each ink color. Here, assume that, for example, each of Cout, Mout, Yout, and Kout is expressed by 10 bits and takes a range from 0 to 1023. Hence, the occurrence probabilities of print dots are Cout/1023, Mout/1023, Yout/1023, and Kout/1023. Finally, printing is executed based on the generated binary data.

### <Color Conversion Processing>

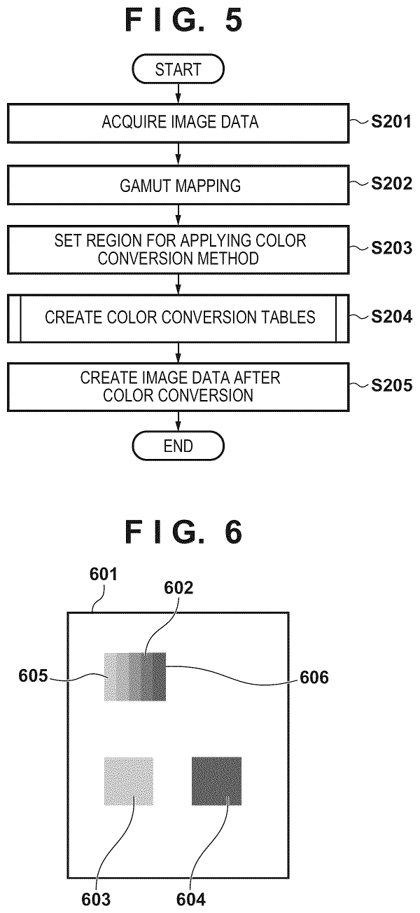

FIG. 5 is a flowchart for explaining the color conversion processing in step S103 of FIG. 3 according to the first embodiment. The processing shown in FIG. 5 is implemented when, for example, the CPU 111 executes a program read out to the RAM 112.

In step S201, the CPU 111 acquires image data for the color conversion processing. The image data acquired in this embodiment is partial original data output in step S102 described above, and is, for example, image data of each page. The image data includes color information representing a color defined in a predetermined color space. The image data according to this embodiment is sRGB data including color information in which the SRGB space is defined. The image data is not limited to this, and may be data in any format such as Adobe RGB data, CIE-L*a*b* data, CIE-LUV data, XYZ color system data, xyY color system data, HSV data, or HLS data as long as the color space can be defined.

Next, in step S202, the CPU 111 performs color conversion for the image data using a color conversion table stored in advance in the storage medium 113. Color conversion according to this embodiment is gamut mapping of the image data, and is mapping of the color reproduction region of the sRGB data to the color reproduction region of the printing apparatus 108. The printing apparatus 108 has a different color reproduction region depending on a printing method, a printing speed, and the like decided for each output mode. Therefore, the printing apparatus 108 requires gamut mapping corresponding to each of the plurality of output modes. The image data obtained after gamut mapping is stored in the RAM 112 or the storage medium 113. More specifically, for example, the color conversion table (gamut mapping table) is a three-dimensional LUT. By the three-dimensional LUT, a combination of the output pixel values (Rout, Gout, Bout) can be calculated with respect to a combination of input pixel values (Rin, Gin, Bin). If each of the input values Rin, Gin, and Bin has 256 tones, a color conversion table LUT1 [256] [256] [256] [3] having 256×256×256=16,777,216 sets of output values in total is preferably used. More specifically, color conversion using the gamut mapping table is implemented by executing, for each pixel of the image formed by the RGB pixel values of the image data input in step S101, processing given by:

$$Rout = LUT 1 [ Rin ] [ Gin ] [ Bin ] [ 0 ] \qquad ( 13 )$$

$$Gout = LUT 1 [ Rin ] [ Gin ] [ Bin ] [ 1 ] \qquad ( 14 )$$

$$Bout = LUT 1 [ Rin ] [ Gin ] [ Bin ] [ 2 ] \qquad ( 15 )$$

The table size may be reduced by decreasing the number of grids of the LUT from 256 grids to, for example, 16 grids and deciding output values by interpolating table values of a plurality of grids.

In step S203, based on the image data acquired in step S201, the CPU 111 sets a first region to which a color conversion method set in step S203 of the succeeding stage is applied and a second region to which the color conversion method set in step S203 is not applied. In this example, a region to which a color conversion table that places importance on the discriminability of colors is not applied is set as the second region. The second region is, for example, a region that places importance on the tonality of colors.

FIG. 6 shows an example of image data 601 acquired in step S201 according to this embodiment. The image data 601 includes a gradation region 602, a first solid region 603, and a second solid region 604, and the remaining region is a white region. The color of the first solid region 603 will also be referred to as the color 603 hereinafter. The color of the second solid region will also be referred to as the color 604 hereinafter. The gradation region 602 is a region where horizontal gradation is drawn, the color at a left end 605 of the gradation region 602 is the color 603 having a color value equal to the color value of the first solid region, and the color at a right end 606 of the gradation region 602 is the color 604 having a color value equal to the color value of the second solid region. There exist, between the left end 605 and the right end 606, pixels of gradation that continuously changes in lightness between the colors 603 and 604.

In this embodiment, the solid region is a region of the image data having the same color value in two or more pixels in the vertical direction and two or more pixels in the horizontal direction. This is because if the printing resolution of the printing apparatus is low or the amount of ink droplets formed on the print medium (however, the present disclosure is not limited to the ink droplets as long as an image can be formed on the print medium) is large, a person can recognize, as a solid region, even a region of two pixels in the vertical direction and two pixels in the horizontal direction on the print medium. Therefore, the number of pixels of the image data of the solid region may be two or more pixels in the vertical direction and two or more pixels in the horizontal direction in accordance with the printing resolution of the printing apparatus 108 and the amount of ink droplets. Furthermore, in this embodiment, the gradation region 602, the first solid region 603, and the second solid region 604 are surrounded by white data. The white data is data of R=255, G=255, and B=255 for, for example, 8-bit RGB data. The white data need only surround the region with two or more pixels, similar to the solid region, so that a person can recognize the gradation region and the solid region.

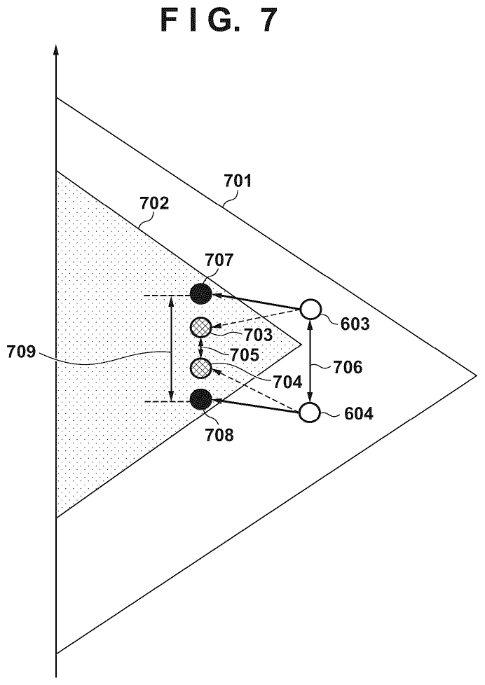

FIG. 7 is a view for explaining color degeneration and its correction (resolution). FIG. 7 shows a case where the image data before color conversion is as shown in FIG. 6. A color reproduction region 701 is the color reproduction region of the image data, and indicates the color reproduction region of sRGB in this embodiment. A color reproduction region 702 is a color reproduction region after color conversion processing in step S205 to be described later, and corresponds to a color reproduction region (device color gamut) in a predetermined output mode of the printing apparatus 108.

In FIG. 7, a color 703 is a color obtained after performing color conversion for the color 603 by gamut mapping. A color 704 is a color obtained after performing color conversion for the color 604 by gamut mapping. In this embodiment, in a case where a color difference ΔE 705 between the colors 703 and 704 is smaller than a color difference ΔE 706 between the colors 603 and 604, it is determined that color degeneration has occurred. In this embodiment, in a case where a color difference obtained by performing gamut mapping to the color reproduction region in the predetermined output mode of the printing apparatus 108 is smaller than a color difference in the color reproduction region of the image data, it is determined that color degeneration has occurred. However, the present disclosure is not limited to this, and for example, color degeneration may be determined after multiplying one of the color differences in the two color reproduction regions by a coefficient. This can adjust the correction amount of color degeneration correction in a case where the difference between the color differences in the two color reproduction regions is too large. This embodiment describes an example in which the colors 603 and 604 fall outside the color reproduction region 702 (color gamut) in the predetermined output mode of the printing apparatus 108. The present disclosure is not limited to this. Both the colors 603 and 604 may fall within the color reproduction region 702, or one of the colors 603 and 604 may fall outside the color reproduction region 702. When at least one of the colors 603 and 604 falls outside the color reproduction region 702, color degeneration readily occurs. This is because the color outside the color gamut needs to undergo gamut mapping in order to reproduce the color in the color reproduction region 702.

As a method of calculating a color difference ΔE, a Euclidean distance in a color space is used. In this embodiment, as an example, a Euclidean distance (to be referred to as a color distance ΔE hereinafter) in the CIE-L*a*b* color space is used. Since the CIE-L*a*b* color space is a visual uniform color space, the Euclidean distance serves as an approximation of the change amount of the color. Therefore, a person perceives that the colors become closer as the Euclidean distance on the CIE-L*a*b* color space is smaller and that the colors are farther apart as the Euclidean distance is larger. The color information in the CIE-L*a*b* color space is represented in a color space with three axes of L*, a*, and b*. The color difference ΔE between a color (L1, a1, b1) and a color (L2, a2, b2) is calculated by:

$$Δ E = \sqrt{{( {L}_{1} - {L}_{2} )}^{2} + {( {a}_{1} - {a}_{2} )}^{2} + {( {b}_{1} - {b}_{2} )}^{2}} \qquad ( 16 )$$

When the color conversion table that places importance on the tonality of colors and has been stored in advance in the storage medium 113 is applied to the gradation region 602 shown in FIG. 6 in step S202, the printing apparatus 108 outputs smooth gradation that connects the color 703 to the color 704 in FIG. 7. Even if color degeneration occurs when the colors 603 and 604 in the gradation region 602 are printed in the colors 703 and 704, respectively, if gradation that smoothly connects the colors 703 and 704 is printed, the user will not find the print result unnatural. On the other hand, if the color 603 of the first solid region 603 is output in the color 703 and the color 604 of the second solid region is output in the color 704, the discriminability when printing the first solid region 603 and the second solid region 604 decreases due to color degeneration, as compared with the digital original.

In this embodiment, a color conversion table for correcting color degeneration by increasing the distance between the colors 703 and 704 on the predetermined color space is generated. More specifically, correction processing is performed to increase the distance between the colors 703 and 704 to a distance equal to or larger than the distance at which the colors can be identified as different colors based on the human visual characteristic. In terms of the human visual characteristic, as the distance between the colors at which the colors can be identified as different colors, the color difference ΔE of CIE76 (a standard for a color space adopted by the International Commission on Illumination) is set to 2.0 or more. Therefore, for example, the color difference between the colors 703 and 704 is desirably equal to the color difference ΔE 706. Thus, a color conversion table for gamut mapping of the color 603 to a color 707 and the color 604 to a color 708 is generated. As a result, it is possible to reproduce a color difference ΔE 709 equal to the color difference ΔE 706 in the device color gamut.

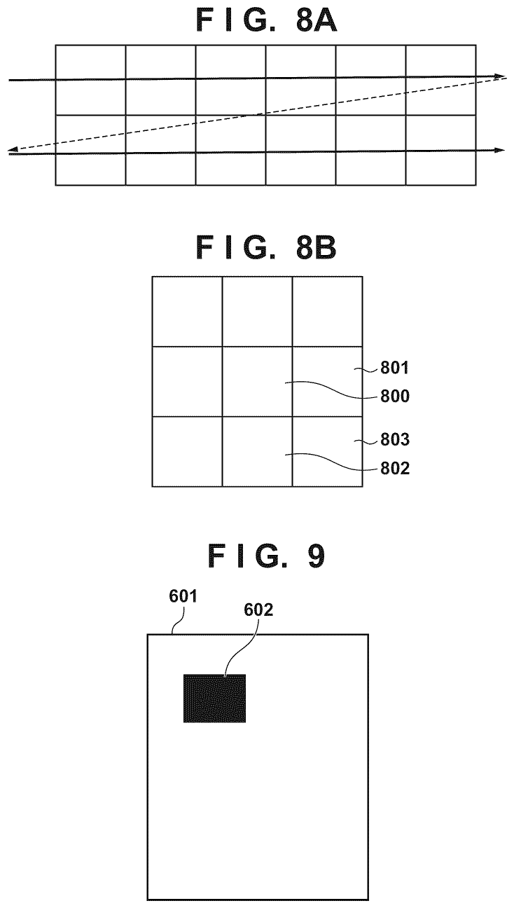

The setting, in step S203, of the second region to which the color conversion table that places importance on the discriminability of colors is not applied will be described next with reference to FIGS. 8A and 8B. As indicated by arrows in FIG. 8A, sequential processing is performed for image data of each pixel in line processing. In the processing for each pixel, as shown in FIG. 8B, it is determined whether color information of three peripheral pixels (pixels 801, 802, and 803) of a pixel 800 of interest (a pixel to be processed) is contiguous with the color information of the pixel of interest. In this embodiment, if the color information of each of the three peripheral pixels of the pixel 800 of interest is not identical to the color information of the pixel 800 of interest and the color difference ΔE is not larger than 2.0, the pixel of interest is set as the second region. A pixel that has already been set as the second region may be reset as the second region in the processing for each pixel. In this embodiment, the second region is set using the above-described sequential processing. However, the present disclosure is not limited to this as long as it is possible to set, as image data, a region where the color information continuously changes. With respect to the image data shown in FIG. 6, the gradation region 602 is set as the second region. FIG. 9 shows the second region set in the processing in step S203. That is, a black region (that is, the gradation region 602) shown in FIG. 9 is set as the second region, and a white region (that is, the region other than the gradation region) is set as the first region. Steps S202 and S203 may be executed simultaneously.

Next, in step S204, the CPU 111 generates color conversion tables for the first region and the second region set in step S203. The color conversion table for the first region set in step S203 is generated based on the following information.
The image data acquired in step S201
The color conversion table stored in advance in the storage medium 113 and used in step S202
The image data obtained in step S202 by performing color conversion using the color conversion table stored in advance in the storage medium 113
The region information set in step S203

With respect to the second region, a color conversion table that places importance on the tonality, is different from the color conversion table stored in advance in the storage medium 113 and used in step S202, and has been stored in advance in the storage medium 113 is set.

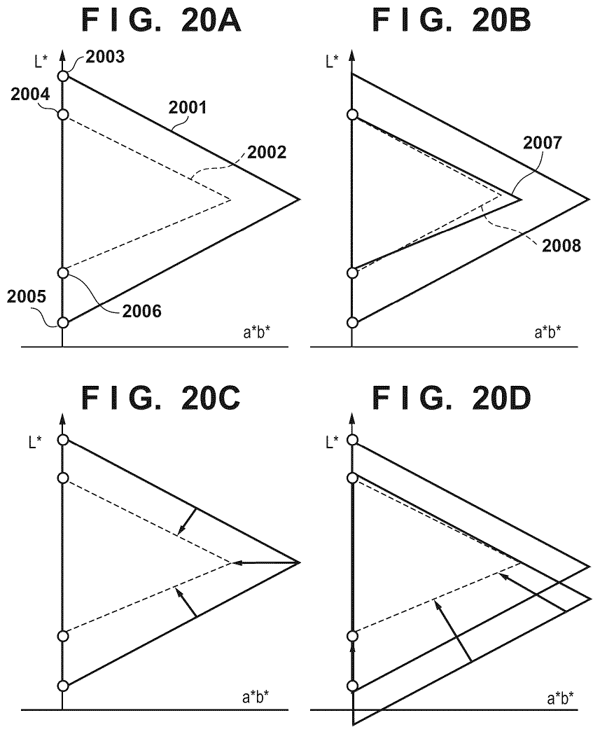

Examples of the color conversion table stored in advance in the storage medium 113 and used in step S202 and the color conversion table that places importance on the tonality and has been stored in advance in the storage medium 113 will now be described with reference to FIGS. 20A to 20D.

FIG. 20A is a view showing the relationship between the color space of a standard display and the color space of the printing apparatus 108. This is generally called color space compression (color mapping). A plurality of color space compression methods exist, and these are selectively used in accordance with the purpose. In FIG. 20A, a WP 2003 and a WP 2004 indicate the brightest colors (white points) in the color reproduction ranges of the standard display and the printing apparatus 108, respectively. In addition, a BP 2005 and a BP 2006 indicate the darkest colors (black points) in the color reproduction ranges of the standard display and the printing apparatus 108, respectively.

FIG. 20B is a view for explaining an example of a color conversion method applied to a region that places importance on the tonality of colors. As indicated by a solid line 2007 in FIG. 20B, the white point and the black point on the standard display are mapped to the white point and the black point on the printing apparatus 108, respectively. The remaining colors are converted such that the correlation relationship with the white point and the black point is maintained. Color conversion is performed by compressing the chroma on the color direction such that a whole color space 2001 of the standard display is fitted in a color reproduction gamut 2002 of the printing apparatus 108. Hence, colors on the color space 2001 of the standard display are converted to the thick line 2007, and colors on the original color reproduction gamut 2002 are converted to a broken line 2008. The color conversion method shown in FIG. 20B is suitable for processing of image data such as a photo containing a lot of colors. In FIG. 20B, color compression is performed for both lightness and chroma almost on the whole color gamut of the standard display.

FIG. 20C is a view for explaining an example of the color conversion method applied to a region that places importance on the discriminability of colors and used in step S202. This is a method of performing color compression not for colors in the color reproduction gamut of the printing apparatus 108 but for colors outside the color reproduction gamut concerning both lightness and chroma, as shown in FIG. 20C. Thick arrows in FIG. 20C represent color compression processing. A plurality of colors included in the thick arrows are expressed as different colors on the standard display but may be the colors at the ends of the arrows after the mapping, thereby causing color degeneration. A color conversion method shown in FIG. 20D may be applied to the region that places importance on the discriminability of colors. This is a method of mapping only the white point on the standard display to the white point on the printing apparatus 108, and after that, performing color compression not for colors in the color reproduction gamut of the printing apparatus 108 but for colors outside the print color gamut concerning both lightness and chroma, as shown in FIG. 20D. This aims to reproduce the relative color difference between white color and each color in the standard display as the relative color difference between paper white and each color at the time of printing, and is called “relative colorimetric”. Even in this color conversion method, a plurality of colors included in the thick arrows are expressed as different colors on the standard display but may be the same colors at the ends of the arrows after the color conversion, thereby causing color degeneration.

Next, in step S205, the CPU 111 executes color conversion based on the following information.
The region information set in step S203.
The color conversion table for the first region set in step S204
The color conversion table for the second region set in step S204, which places importance on the tonality of colors and has been stored in advance in the storage medium 113

In this embodiment, for the image data acquired in step S201, with respect to the first region set in step S203, image data after the color conversion is generated by performing calculation using the color conversion table for the first region set in step S204. On the other hand, with respect to the second region set in step S203, image data after the color conversion is generated by performing calculation using the color conversion table that places importance on the tonality of colors, has been set in step S204, and has been stored in advance in the storage medium 113. The generated image data is stored in the RAM 112 or the storage medium 113.

### <Setting of Color Conversion Method (Generation of Color Conversion Table)>

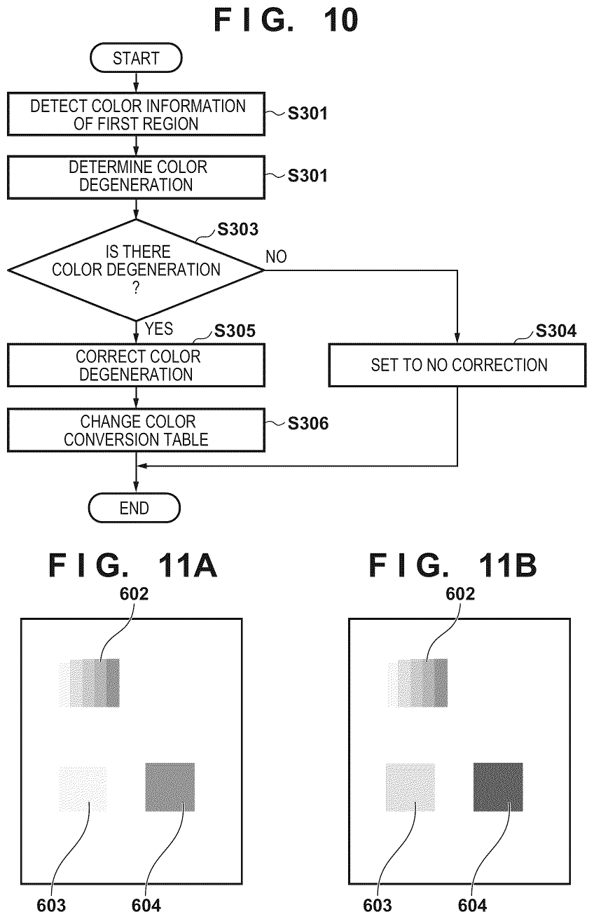

A method of generating, in step S204, a color conversion table for reducing color degeneration, which is set for the first region, will be described in detail with reference to a flowchart shown in FIG. 10. The processing shown in FIG. 10 is implemented when, for example, the CPU 111 executes a program read out to the RAM 112.

In step S301, the CPU 111 detects the color information of the first region in FIG. 9 which has been set in step S203. The detection processing is repeated for each pixel of the image data of the first region, and is executed for all the pixels included in the image data of the first region. In this embodiment, the colors 603 and 604 shown in FIG. 6 are detected. Note that a color information list is initialized at the start of step S301.

In step S302, the CPU 111 detects the number of combinations of colors subjected to color degeneration among combinations in the color information list based on the color information list detected in step S301. In this example, the combination of the colors 603 and 604 is detected as a combination subjected to color degeneration, as described with reference to FIG. 7.

In step S303, the CPU 111 determines whether the number of combinations of colors subjected to color degeneration in step S302 is zero. If it is determined that the number of combinations of colors subjected to color degeneration is zero, the process advances to step S304, and it is determined that it is unnecessary to perform color degeneration correction for the image data. In this case, as a color conversion table, the color conversion table stored in advance in the storage medium 113 and used in step S202 is set. If it is determined that the number of combinations of colors subjected to color degeneration is not zero, the process advances to step S305, and the CPU 111 performs color degeneration correction.

Color degeneration correction changes the colors. Thus, the combinations of colors not subjected to color degeneration are also changed, which is unnecessary. Therefore, based on the total number of combinations in the color information list and the number of combinations of colors subjected to color degeneration, it may be determined whether color degeneration correction is necessary. More specifically, for example, in a case where the majority of all the combinations in the color information list are combinations of colors subjected to color degeneration, it may be determined that color degeneration correction is necessary (that is, it may be determined in step S303 to perform color degeneration correction). This can suppress adverse effects of a color change caused by color degeneration correction. For example, FIG. 6 shows the solid regions with respect to the two colors 603 and 604. If solid regions of 10 colors are shown, the total number of combinations is 45. In this case, if the number of combinations of colors subjected to color degeneration is, for example, 23 or more, it may be determined that color degeneration correction is necessary.

In step S305, based on the image data, the image data having undergone the color conversion, and the color conversion table, the CPU 111 performs color degeneration correction for the combinations of the colors subjected to color degeneration. As described with reference to FIG. 7, color degeneration correction is performed so that the color difference ΔE 705 between the colors 703 and 704 becomes the color difference ΔE 709 between the colors 707 and 708, which is equal to the color difference ΔE 706. The color degeneration correction processing is repeated the number of times that is equal to the number of combinations of the colors subjected to color degeneration. Results of performing color degeneration correction, the number of which is equal to the number of combinations of the colors, are held in a table in which color information before correction is associated with color information after correction. In FIG. 7, the color information is color information in the CIE-L*a*b* color space. Therefore, the input image data may be converted into the color space of the output image data. In this case, the results are held in a table in which color information before correction in the color space of the input image data is associated with color information after correction in the color space of the output image data.

The colors 707 and 708 are on the extension between the colors 703 and 704 in FIG. 7 but this embodiment is not limited to this. As long as the color difference ΔE 709 between the colors 707 and 708 is equal to the color difference ΔE 706, the direction can be any of the lightness direction, the chroma direction, and the hue angle direction in the CIE-L*a*b* color space. Not only one direction but also any combination of the lightness direction, the chroma direction, and the hue angle direction may be used. Furthermore, FIG. 7 shows an example of correcting both the colors 703 and 704, but correction may be performed to obtain the color difference ΔE 706 by correcting only one of the colors.

In step S306, the CPU 111 changes the color conversion table using the result of the degeneration correction in step S305 (performs color regeneration correction). The color conversion table before the change is a table for converting the colors 603 and 604 in FIG. 6 into the colors 703 and 704, respectively. By using the result of step S305, the table is changed to a color conversion table for converting the colors 603 and 604 in FIG. 6 into the colors 707 and 708, respectively (setting of the color conversion method). On the other hand, if it is determined in step S303 not to perform color degeneration correction, the processing in step S306 is not performed. In other words, the processing in step S303 is processing of determining whether to change the color conversion table in step S306. In this way, the color degeneration-corrected color conversion table can be generated. The color conversion table is repeatedly changed the number of times that is equal to the number of combinations of the colors subjected to color degeneration.

### <Print Result>

FIGS. 11A and 11B are views each showing an image of a print result according to this embodiment. FIG. 11A shows a print result obtained by performing color conversion for the partial original data shown in FIG. 6 by the color conversion table stored in advance in the storage medium 113 and used in step S202, and FIG. 11B shows a print result obtained by performing color conversion according to this embodiment. In both FIGS. 11A and 11B, since the gradation region 602 undergoes color conversion by the color conversion table that places importance on the tonality of colors and has been stored in advance in the storage medium 113, the thus obtained print result is the same, and smooth gradation is reproduced. On the other hand, if the first solid region 603 and the second solid region 604 undergo color conversion by the color conversion table stored in advance in the storage medium 113, a print result with reduced discriminability between the solid regions is obtained due to color degeneration, as shown in FIG. 11A. In this embodiment, by applying the color conversion table corrected in step S305 to the solid regions, it is possible to obtain a print result with discriminability close to that of the digital original as the partial original data between the solid regions, as shown in FIG. 11B.

The color difference between the first solid region 603 and the second solid region 604 in FIG. 11B is the CIE76 color difference calculated by equation (16) from a colorimetric result by a colorimeter, and is 2.0 or more. This is a color difference that is defined by CIE76 and is equal to or larger than the minimum value of the range of the color difference that can be identified when a person compares two colors at a short distance. As a result of performing color reproduction by gamut mapping on a print medium with a narrow color reproduction region, it is possible to ensure the minimum discriminability identifiable by a person.

In the print result shown in FIG. 11B, the color difference defined by CIE76 and calculated from colorimetric values obtained by performing colorimetry at the positions of the first solid region 603 and the second solid region 604 is larger than the color difference defined by CIE76 and calculated from colorimetric values obtained by performing colorimetry at the positions of the colors 603 and 604 at the left end 605 and the right end 606 of the gradation region 602.

According to this embodiment, the first region that places importance on the discriminability of colors and the second region different from the first region are set in image data including no type information. The second region is, for example, a gradation region that places importance on the tonality of colors. Then, by not applying, to the second region, the color conversion method generated from the first region, color conversion that can implement the discriminability and the tonality is executed. As a result, it is possible to obtain a preferable print result including a color difference between the solid regions, which can be perceived by a person, while maintaining the tonality of the gradation region.

In this embodiment, the color conversion table that places importance on the tonality of colors and has been stored in advance in the storage medium 113 is applied to the second region. However, if the color conversion table stored in advance in the storage medium 113 and used in step S202 is applicable, it may be applied to the second region.

This embodiment has explained an example of generating a color conversion table after color degeneration correction to be applied to the first region. However, the above-described color conversion table that places importance on the discriminability of colors and has been stored in advance in the storage medium 113 may be applied. As a result, it is possible to reduce the processing time for generating a color conversion table.

Furthermore, in this embodiment, the color conversion table stored in advance in the storage medium 113 is used to set a color conversion table, and a color conversion table is created in the same format as that of the color conversion table. However, for example, color conversion in step S202 may be performed by a predetermined rule such that a color is relatively converted from the color reproduction region of the acquired image data into the color reproduction region of the printing apparatus 108 without using the color conversion table stored in the storage medium 113. As a result, it is unnecessary to hold in advance the color conversion table in the storage medium 113, and it is possible to reduce a storage capacity. In the setting of the color conversion method in step S204, without setting the color conversion table, pieces of color information before and after color conversion may be set in one-to-one correspondence with each other (so-called dictionary form), or a formula may be set in a case where approximation can be performed using the formula. As a result, it is possible to reduce a storage capacity for holding the color conversion method, as compared with the color conversion table.

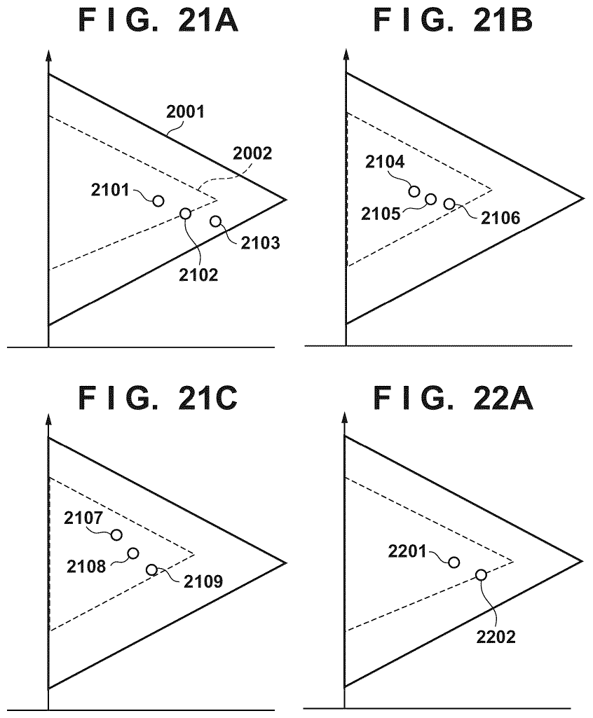

A case where the same effect can be obtained even if the color conversion table used for the first region and the color conversion table used for the second region in step S204 are the same will be described below with reference to FIGS. 21A to 21C. FIG. 21A is a view showing the relationship among the color space 2001 of the standard display, the color space 2002 of the printing apparatus 108, and colors 2101, 2102, and 2103. The color 2101 is a color existing in the color space 2002, the color 2102 is a color existing on the surface of the color space 2002, and the color 2103 is a color existing in the color space 2001. Next, FIG. 21B shows a result of performing color conversion for the colors 2101, 2102, and 2103 by the color conversion table used in step S204. This example shows an example in which the color conversion method that places importance on the tonality, as shown in FIG. 20B, is used. However, the present disclosure is not limited to this, and any color conversion table that has a different feature may be used as long as no problem arises by applying the color conversion table to the second region. The colors 2101, 2102, and 2103 are converted into colors 2104, 2105, and 2106, respectively, by gamut mapping, and as a result of color conversion, color degeneration occurs. FIG. 21C shows a result of performing color degeneration correction for the colors 2104, 2105, and 2106. As a result of color degeneration correction, the colors 2101, 2102, and 2103 are finally converted into colors 2107, 2108, and 2109, respectively. In a case where the colors 2101, 2102, and 2103 exist in the first region and the second region, these colors are converted into the colors 2107, 2108, and 2109, respectively, in the first region. On the other hand, in the second region, these colors are converted into the colors 2104, 2105, and 2106, respectively. In this way, even if the color conversion table used for the first region and that used for the second region are the same, it is possible to reduce color degeneration (improve the discriminability) by performing color degeneration correction in the first region that places importance on the discriminability while maintaining the tonality of colors in the second region that places importance on the tonality.

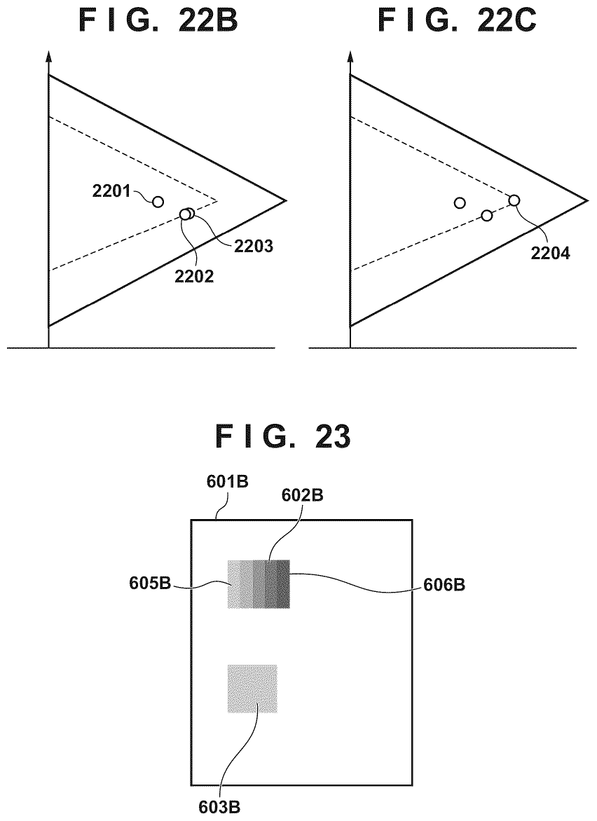

A case where the effect of reducing color degeneration is obtained by making the color conversion tables used for the first region and the second region different from each other (switching between them) in step S204 without performing color degeneration correction shown in FIG. 10 will be described. Such case corresponds to, for example, a case where it is determined in step S303 that no color degeneration occurs and the process advances to step S304. An example in a case where the color conversion method, shown in FIG. 20C, that places importance on the discriminability is used for the first region and the color conversion method, shown in FIG. 20B, that places importance on the tonality is used for the second region will be described with reference to FIG. 22A. FIG. 22A is a view showing a result of performing color conversion for the colors 2101 and 2102 in FIG. 21A, that is, the colors 2101 and 2102 of the first region by the color conversion method, shown in FIG. 20C, that places importance on the discriminability. The colors 2101 and 2102 are converted into colors 2201 and 2202, respectively, by gamut mapping. With respect to the colors 2101 and 2102, color degeneration occurs in the colors 2104 and 2105 converted by the color conversion method, shown in FIG. 20B, that places importance on the tonality, but no color degeneration occurs in the colors 2201 and 2202. That is, by switching the color conversion table between the first region and the second region, the effect of reducing color degeneration is obtained. Depending on the input color, color degeneration may occur. Such case corresponds to, for example, a case where it is determined in step S303 that color degeneration occurs and the process advances to step S305. FIG. 22B shows an example in which a color 2203 obtained by converting the color 2103 by the color conversion method, shown in FIG. 20C, that places importance on the discriminability is added to FIG. 22A. The colors 2202 and 2203 are converted into almost the same color, and color degeneration occurs. In this case, as described in the above embodiment, it is possible to reduce color degeneration by performing color degeneration correction. FIG. 22C shows an example in which color degeneration correction is performed for the color 2203. The color 2203 undergoes color degeneration correction to obtain a color 2204, resulting in reduction of color degeneration.

### Second Embodiment

The second embodiment will be described below concerning points different from the first embodiment. In the first embodiment, the first region that places importance on the discriminability of colors and the second region that places importance on the tonality of colors are set in the image data including no type information. An arrangement for executing color conversion that can implement the discriminability and the tonality by not applying, to the second region that places importance on the tonality of colors, the color conversion method generated from the first region has been explained. However, if the color conversion method is set using all the colors of the first region that places importance on the discriminability of colors, it may be impossible to generate a color conversion table that ensures sufficient discriminability.

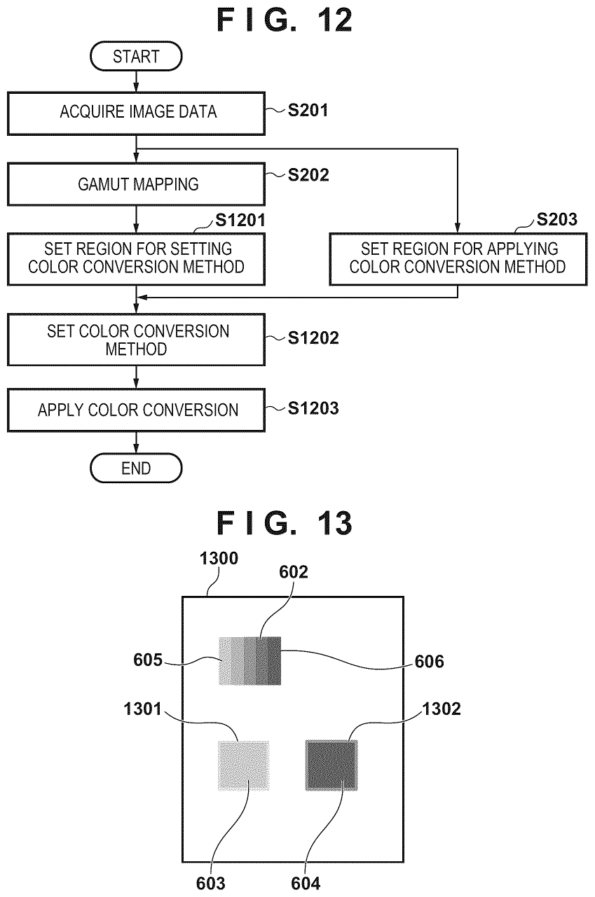

FIG. 12 is a flowchart for explaining color conversion processing in step S103 of FIG. 3 according to the second embodiment. The processing shown in FIG. 12 is implemented when, for example, a CPU 111 executes a program read out to a RAM 112. Steps S201 to S203 are the same as in the first embodiment and a description thereof will be omitted. Steps S202 and S1201 and step S203 are executed simultaneously. Furthermore, successive processing may be performed in the order of steps S201, S203, and S202.

In step S1201, the CPU 111 sets, on an image represented by image data acquired in step S201, a third region to be used to set a color conversion method of the image data and a fourth region not to be used to set the color conversion method of the image data (region setting). In this embodiment, the setting of the color conversion method is generation of a color conversion table of gamut mapping. In the setting of the color conversion method, a conversion formula may be generated or a color conversion table may be generated. Any method may be adopted as long as it is possible to set a method capable of executing color conversion.

FIG. 13 shows an example of the image data acquired in step S201 according to this embodiment. FIG. 13 shows an image obtained by converting image data of a first solid region 603 and a second solid region 604 shown in FIG. 6 to a low resolution by simple thinning and then converting the image data to the original resolution again by bilinear interpolation. That is, FIG. 13 shows an example of data obtained by editing only the solid regions. As image data generated from an image editing application or the like in a PC 101, data obtained by performing resolution conversion and compression for partial image data may be used. As shown in FIG. 13, a one-pixel color region 1301 surrounding the first solid region is generated around the first solid region 603. A one-pixel color region 1302 surrounding the second solid region 604 is generated around the second solid region 604. The color of the color region 1301 will also be referred to as the color 1301 hereinafter and the color of the color region 1302 will also be referred to as the color 1302 hereinafter. In FIG. 6, there are only the two colors 603 and 604 as the colors of the solid regions, but in FIG. 13, the colors 1301 and 1302 are generated by the above-described resolution conversion in addition to the colors 603 and 604. In general, if resolution conversion is performed as described above, the color 1301 generated without user's intention is close to the color 603, and the color 1302 generated without user's intention is similarly close to the color 604. However, although these colors are close to each other, the colors 1301 and 603 and the colors 1302 and 604 are respectively separated from each other by a color difference ΔE of 2.0 or more, unlike a gradation region. In this embodiment, the one-pixel color region surrounding the solid region is shown. However, a one- or more-pixel color region surrounding the solid region may be used as long as it is not determined as the gradation region exemplified in the first embodiment.

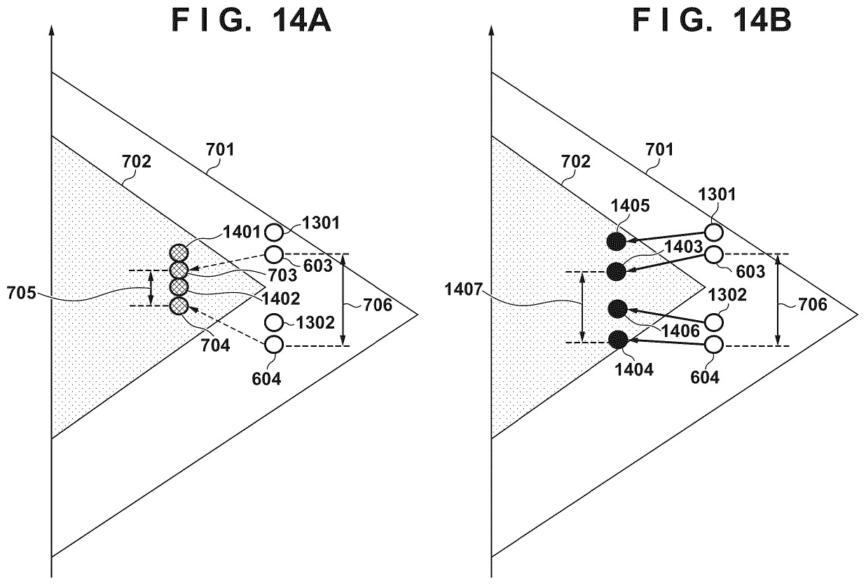

FIGS. 14A and 14B are views for explaining color degeneration and its improvement (resolution) according to this embodiment. In FIGS. 14A and 14B, a color 1401 is a color obtained after performing color conversion for the color 1301 by gamut mapping. A color 1402 is a color obtained after performing color conversion for the color 1302 by gamut mapping. By performing correction of increasing the distance between the colors to correct color degeneration as described above, a color conversion table for performing gamut mapping of the colors 603, 604, 1301, and 1302 to colors 1403, 1404, 1405, and 1406, respectively, is generated. Therefore, although there is a distance between the colors, it may be impossible to increase the distance between the colors in a device color gamut such that a color difference ΔE 1407 between the colors 1403 and 1404 becomes 2.0 or more or equal to a color difference ΔE 706. As a result, the color 603 of the first solid region 603 and the color 604 of the second solid region 604 are colors that can be identified on the display of a monitor but may be unidentifiable in a print result of a printing apparatus 108.

To cope with this, in this embodiment, instead of setting the color conversion method using color information of all pixels in the first region according to the first embodiment, the third region to be used to set the color conversion method of input image data and the fourth region not to be used to set the color conversion method of the input image data are set and a color conversion method is set using the color information of the third region. As will be described later, in this embodiment, the third region is set from the input image data, and a color conversion table is generated only for the color information of the third region. As a result, even if the image data shown in FIG. 14A is input, the color conversion method suitable for discrimination between colors, which is shown not in FIG. 14B but in FIG. 7, can be set, and it is possible to improve a status in which the color difference cannot be identified in the output of the printing apparatus 108.

In this embodiment, color information of image data that can be identified by a person and discriminated in the output of the printing apparatus 108 indicates a region planarly having an area equal to or larger than a predetermined area, and this region is set as the third region. Therefore, a region where two or more pixels having the same color information continue in each of the vertical direction and the horizontal direction in the image data is set as the third region. The setting of the third region according to this embodiment will be described with reference to FIGS. 8A and 8B. As indicated by arrows in FIG. 8A, in this embodiment, sequential processing is performed for image data of each pixel in line processing. In the processing for each pixel, as shown in FIG. 8B, it is determined whether color information of three peripheral pixels (pixels 801, 802, and 803) of a pixel 800 to be processed (pixel of interest) is identical to the color information of the pixel of interest. If the determination result indicates that the pieces of color information are identical to each other, the four pixels including the pixel of interest are set as the third region. A pixel that has already been set as the third region may be reset as the third region in the processing for each pixel. In this embodiment, the third region is set using the above-described processing. However, the present disclosure is not limited to this as long as it is possible to set a region having the same color information and planarly having an area equal to or larger than a predetermined area. In this embodiment, the region having the same color information is set. However, the same color information in the original image data may vary within a predetermined range in, for example, image data having undergone lossy compression such as JPEG data. To cope with this, an allowable range of variations may be set by, for example, setting the color difference ΔE to 1.0 or less or setting the difference in RGB values to a predetermined value or less with respect to the region having the same color information.

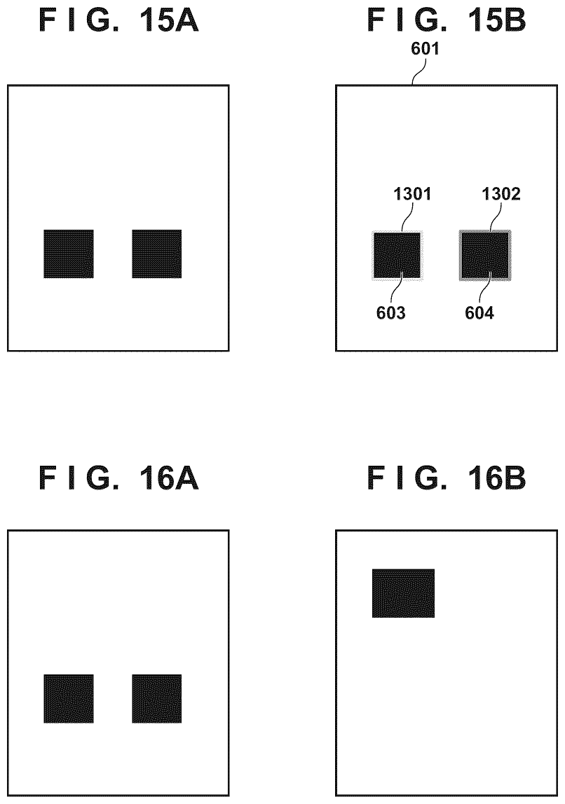

As a result of the setting, in this embodiment, with respect to any of the image data shown in FIGS. 6 and 13, a black region shown in FIG. 15A is set as the third region and a white region shown in FIG. 15A is set as the fourth region. In other words, even if the colors 1301 and 1302 unintended by the user are generated, these colors are not considered when setting the color conversion method of the input image data.

As shown in FIGS. 15A and 15B, in this embodiment, as color information of image data that can be identified by a person and discriminated in the output of the printing apparatus 108, the color 603 of the first solid region 603 and the color 604 of the second solid region 604 each planarly having an area equal to or larger than a predetermined area are set. As shown in FIG. 15B, the colors 1301 and 1302 are colors not in the third region to be used to generate a color conversion table after color degeneration correction (to be used to set a color conversion method) but in the fourth region adjacent to the third region. As described above, since the color 1301 is close to the color 603 and the color 1302 is close to the color 604, the colors 1301 and 1302 are also converted by the color conversion table after color degeneration correction. In other words, a region to which the color conversion table after color degeneration correction is applied can be a region including the third region and at least a part of the fourth region. As described above, by making the region to be used to generate a color conversion table after color degeneration correction different from the region to which the generated color conversion table after color degeneration correction is applied, it is possible to prevent unnecessary color degeneration correction and obtain an optimum output image.

FIG. 16B shows the first region that is set in step S203 and to which a color conversion table that places importance on the discriminability of colors is applied and a second region that is set in step S203 and to which the color conversion table that places importance on the discriminability of colors is not applied. In FIG. 16B, the second region is shown as a black region, and the first region is shown as a white region. As shown in FIGS. 16A and 16B, a condition for setting the first region and the second region and a condition for setting the third region and the fourth region are desirably set so that the first region applicable with the color conversion method that places importance on the discriminability of colors includes the third region to be used to set the color conversion method that places importance on the discriminability of colors. That is, setting is desirably performed so the third region to be used to set the color conversion method that places importance on the discriminability of colors is not set as the second region to which the color conversion method that places importance on the discriminability of colors is not applied.

Next, in step S1202, the CPU 111 generates, based on the following information, a color conversion table for the first region set in step S203.
The image data acquired in step S201
The color conversion table stored in advance in a storage medium 113 and used in step S202
The image data obtained by performing color conversion using the color conversion table stored in advance in the storage medium 113 in step S202
The region information set in step S1201

Although the color conversion method is set using the region information set in step S1201, the setting of the color conversion method is the same as in the first embodiment and a description thereof will be omitted. As the color conversion table for the second region, a color conversion table that places importance on the tonality of colors and has been stored in advance in the storage medium 113 is set.

Next, in step S1203, the CPU 111 executes color conversion based on the following information.
The region information set in step S203
The color conversion table for the first region, which has been set in step S1202
The color conversion table for the second region set in step S203, which places importance on the tonality of colors and has been stored in advance in the storage medium 113

For the image data acquired in step S201, with respect to the first region set in step S203, image data after the color conversion is generated by performing calculation using the color conversion table for the first region, which has been set in step S1202. On the other hand, with respect to the second region set in step S203, image data after the color conversion is generated by performing calculation using the color conversion table that places importance on the tonality of colors, has been set in step S1202, and has been stored in advance in the storage medium 113. The generated image data is stored in the RAM 112 or the storage medium 113.

### <Print Result>

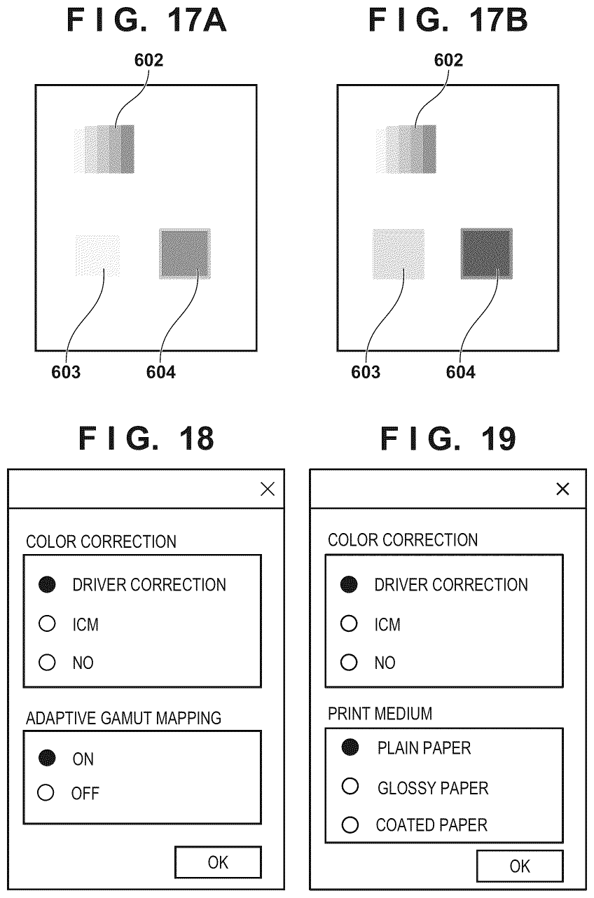

FIGS. 17A and 17B are views each showing an image of a print result according to this embodiment. FIG. 17A shows a print result obtained by performing color conversion for the partial original data shown in FIG. 13 by the color conversion table stored in advance in the storage medium 113 and used in step S202, and FIG. 17B shows a print result obtained by performing color conversion according to this embodiment. In both FIGS. 17A and 17B, since a gradation region 602 undergoes color conversion by the color conversion table that places importance on the tonality of colors and has been stored in advance in the storage medium 113, the thus obtained print result is the same, and smooth gradation is reproduced. On the other hand, similar to the first embodiment, if the first solid region 603 and the second solid region 604 undergo color conversion by the color conversion table stored in advance in the storage medium 113, a print result with reduced discriminability between the solid regions is obtained due to color degeneration, as shown in FIG. 17A. In this embodiment, when the color conversion table set in step S1202 is applied, even if the colors 1301 and 1302 unintended by the user are generated around the first solid region 603 and the second solid region 604, it is possible to obtain a print result with discriminability close to that of the digital original between the solid regions, as shown in FIG. 17B. Similar to the first embodiment, the color difference between the first solid region 603 and the second solid region 604 in FIG. 17B is the CIE76 color difference calculated by equation (16) from a colorimetric result by a colorimeter, and is 2.0 or more.

In the print result shown in FIG. 17B, the color difference defined by CIE76 and calculated from colorimetric values obtained by performing colorimetry at the positions of the first solid region 603 and the second solid region 604 is larger than the color difference defined by CIE76 and calculated from colorimetric values obtained by performing colorimetry at the positions of the colors 603 and 604 at a left end 605 and a right end 606 of the gradation region 602.

In a case where the image data shown in FIG. 6 is input as next partial original data of the image data shown in FIG. 13, a print result of the next page is as shown in FIG. 11B. In the print result obtained by the processing of this embodiment, even if the colors 1301 and 1302 different from those in FIG. 13 and unintended by the user are generated around the first solid region 603 and the second solid region 604, the print result of the first solid region 603 and the second solid region 604 includes completely the same colors as a colorimetric result. That is, in this embodiment, even if the colors 1301 and 1302 unintended by the user are generated, it is possible to ensure the discriminability between the first solid region 603 and the second solid region 604. In addition, if the color value extracted in the third region is the same between pages, the print result of the solid region is the same between the pages.

According to this embodiment, the first region that places importance on the discriminability of colors and the second region different from the first region are set in the image data including no type information. The second region is, for example, a gradation region that places importance on the tonality of colors. In addition, the third region to be used to set a color conversion method of the image data and the fourth region not to be used to set the color conversion method of the image data are set. By setting the respective regions, it is possible to prevent unnecessary color degeneration correction and set an appropriate color conversion method based on only information of the region (that is, the third region) necessary for color degeneration correction. As a result, it is possible to obtain a color conversion result preferable for the printing apparatus 108 with respect to the entire image.

In this embodiment, with respect to color information of image data that can be identified by a person and discriminated in the output of the printing apparatus 108, the third region is set as a region planarly having a predetermined area under the condition that two or more pixels having the same color information continue in each of the vertical direction and the horizontal direction. However, the number of pixels continuing in each of the vertical and horizontal directions may be set in accordance with the output resolution of the printing apparatus 108 and the visual characteristic and the like of a person who observes an output product of the printing apparatus 108. As a result, it is possible to set the third region more optimally. Alternatively, the user who uses the printing apparatus 108 may designate the setting condition of the third region using the user interface (UI) of the printing apparatus 108 or attribute information of the original data. As a result, it is possible to reflect the user's intention in the setting condition of the third region.

This embodiment has explained an example of avoiding degradation in image quality by setting, as the second region, a region whose image quality degrades by applying the color conversion method generated from the third region to the image data and not applying the color conversion method generated from the third region to the second region. However, the first region and the second region may be separated by setting the first region whose image quality does not degrade even by applying the color conversion method generated from the third region to the image data.

In each embodiment, the user may be able to input an instruction of whether to execute color degeneration correction. In this case, a UI screen shown in FIG. 18 or 19 may be displayed on the UI 103 of the PC 101 or a display unit (not shown) mounted on the printing apparatus 108, thereby making it possible to accept a user instruction. On the UI screen shown in FIG. 18, it is possible to prompt the user to select a color correction type by a toggle button. Furthermore, it is possible to prompt the user to select, by a toggle button, ON/OFF of whether to execute “adaptive gamut mapping” indicating the processing described in each embodiment. On the UI screen shown in FIG. 19, it is possible to automatically execute the processing in accordance with selection, by a medium selection toggle button, of ON/OFF of whether to execute “adaptive gamut mapping” indicating the processing described in each embodiment. If plain paper is selected as a print medium, as shown in FIG. 19, the color reproduction region is narrow, and thus “adaptive gamut mapping” is executed. Alternatively, if glossy paper or coated paper is selected, the color reproduction region is wide, and thus “adaptive gamut mapping” is not executed.

With this arrangement, it is possible to switch, in accordance with the user instruction, whether to execute adaptive gamut mapping indicating the processing described in each embodiment. As a result, when the user wants to reduce the degree of color degeneration, gamut mapping described in each embodiment can be executed.

### Third Embodiment

The third embodiment will be described below concerning points different from the first and second embodiments. There is a need to improve color reproduction of noticeability of the solid region while reproducing the tonality of the gradation regionnoticeability.

### <Color Conversion Processing>

FIG. 5 is a flowchart for explaining color conversion processing in step S103 of FIG. 3 according to the third embodiment. The processing shown in FIG. 5 is implemented when, for example, a CPU 111 executes a program read out to a RAM 112.

In step S201, the CPU 111 acquires image data for the color conversion processing. The image data acquired in this embodiment is partial original data output in step S102 described above, and is, for example, image data of each page. The image data includes color information representing a color defined in a predetermined color space. The image data according to this embodiment is sRGB data including color information in which the sRGB space is defined. The image data is not limited to this, and may be data in any format such as Adobe RGB data, CIE-L*a*b* data, CIE-LUV data, XYZ color system data, xyY color system data, HSV data, or HLS data as long as the color space can be defined.

Next, in step S202, the CPU 111 performs color conversion for the image data using a color conversion table stored in advance in a storage medium 113. Color conversion according to this embodiment is gamut mapping of the image data, and is mapping of the color reproduction region of the sRGB data to the color reproduction region of a printing apparatus 108. The printing apparatus 108 has a different color reproduction region depending on a printing method, a printing speed, and the like decided for each output mode. Therefore, the printing apparatus 108 requires gamut mapping corresponding to each of the plurality of output modes. The image data obtained after gamut mapping is stored in the RAM 112 or the storage medium 113. More specifically, for example, the color conversion table (gamut mapping table) is a three-dimensional LUT. By the three-dimensional LUT, a combination of output pixel values (Rout, Gout, Bout) can be calculated with respect to a combination of input pixel values (Rin, Gin, Bin). If each of the input values Rin, Gin, and Bin has 256 tones, a color conversion table LUT1 [256] [256] [256] [3] having 256×256×256=16,777,216 sets of output values in total is preferably used. More specifically, color conversion using the gamut mapping table can be implemented by executing equations (13) to (15) above for each pixel of the image formed by the RGB pixel values of the image data input in step S101.

In step S203, based on the image data acquired in step S201, the CPU 111 sets a first region to which a color conversion method set in step S204 of the succeeding stage is applied and a second region to which the color conversion method set in step S204 is not applied. In this example, a region to which a color conversion table that places importance on the noticeability of colors is not applied is set as the second region. The second region is, for example, a region that places importance on the tonality of colors.

FIG. 23 shows an example of image data 601B acquired in step S201 according to this embodiment. The image data 601B includes a gradation region 602B and a solid region 603B, and the remaining region is a white region. The color of the solid region 603B will also be referred to as the color 603B hereinafter. The gradation region 602B is a region where horizontal gradation is drawn, and the color at a left end 605B of the gradation region 602B is the color 603B having a color value equal to the color value of the solid region. The color at a right end 606B will also be referred to as the color 606B hereinafter. There exist, between the left end 605B and the right end 606B, pixels of gradation that continuously changes in lightness between the colors 603B and 606B.

In this embodiment, the solid region is a region of the image data having the same color value in two or more pixels in the vertical direction and two or more pixels in the horizontal direction. This is because if the printing resolution of the printing apparatus is low or the amount of ink droplets formed on a print medium (however, the present disclosure is not limited to the ink droplets as long as an image can be formed on the print medium) is large, a person can recognize, as a solid region, even a region of two pixels in the vertical direction and two pixels in the horizontal direction on the print medium. Therefore, the number of pixels of the image data of the solid region may be two or more pixels in the vertical direction and two or more pixels in the horizontal direction in accordance with the printing resolution of the printing apparatus 108 and the amount of ink droplets. Furthermore, in this embodiment, the gradation region 602B and the solid region 603B are surrounded by white data. The white data is data of R=255, G=255, and B=255 for, for example, 8-bit RGB data. The white data need only surround the region with two or more pixels, similar to the solid region, so that a person can recognize the gradation region and the solid region.

In this embodiment, the noticeability indicates a degree of attracting the attention of people. When performing gamut mapping, a color in a predetermined color space may decrease in chroma, as compared with the color before gamut mapping. When chroma decreases due to gamut mapping, a color (for example, red with high chroma) whose degree of attracting the attention of people is high and which is used in a digital original decreases in the degree upon printing of the image, and the noticeability decreases. The predetermined color space may be an arbitrary color space. Examples of the color space are the sRGB color space, the Adobe RGB color space, the CIE-L*a*b* color space, the CIE-LUV color space, the XYZ color space, the xyY color space, the HSV color space, and the HLS color space.

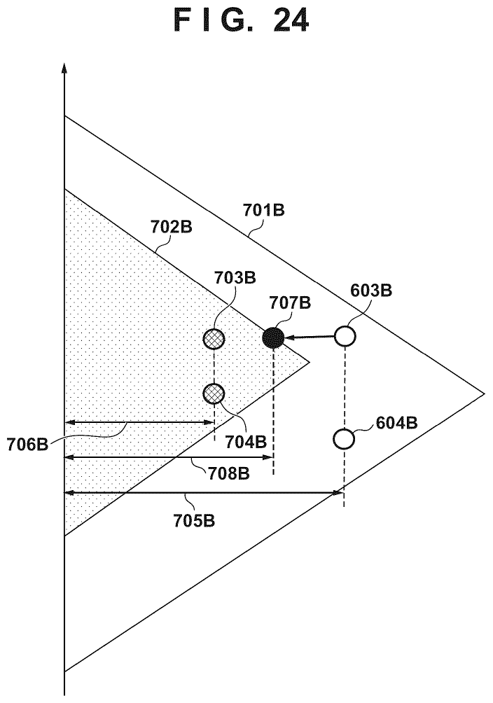

FIG. 24 is a view for explaining a decrease in chroma that results in a decrease in noticeability and its improvement (resolution). A color reproduction region 701B is the color reproduction region of the image data, and indicates the color reproduction region of sRGB in this embodiment. A color reproduction region 702B is a color reproduction region after color conversion processing in step S205 to be described later, and corresponds to a color reproduction region (device color gamut) in a predetermined output mode of the printing apparatus 108.

In FIG. 24, a color 703B is a color obtained after performing color conversion for the color 603B by gamut mapping. A color 704B is a color obtained after performing color conversion for a color 604B by gamut mapping. In this embodiment, in a case where chroma 705B of the color 603B of the image data becomes chroma 706B of the color 703B by performing gamut mapping, it is determined that chroma has decreased. As a result, noticeability decreases in a print result. That is, in this embodiment, in a case where the chroma of the color when performing gamut mapping to the color reproduction region in a predetermined output mode of the printing apparatus is lower than the chroma of the color of the image data, it is determined that the chroma has decreased. However, the present disclosure is not limited to this, and for example, after the chroma of the color in one of the two color reproduction regions is multiplied by a coefficient, a decrease in chroma may be determined. This can adjust a correction amount when correcting a decrease in chroma in a case where a difference in chroma between the two color reproduction regions is too large. This embodiment describes an example in which the color 603B falls outside the color reproduction region 702B (color gamut) in the predetermined output mode of the printing apparatus 108. The present disclosure is not limited to this. The color 603B may fall within the color reproduction region 702B. When the color 603B falls outside the color reproduction region 702B, the chroma readily decreases. This is because the color outside the color gamut needs to undergo gamut mapping in order to reproduce the color in the color reproduction region 702B.

As a method of calculating a chroma difference to confirm a decrease in chroma, a Euclidean distance on a two-dimensional plane of the a-axis and b-axis in the CIE-L*a*b* color space is used in this embodiment. Since the CIE-L*a*b* color space is a visual uniform color space, the Euclidean distance can be approximated into the change amount of the color. Therefore, a person perceives that the colors become closer as the Euclidean distance on the CIE-L*a*b* color space is smaller and that the colors are farther apart as the Euclidean distance is larger. The color information in the CIE-L*a*b* color space is represented in a color space with three axes of L*, a*, and b*. The formula of a chroma difference ΔC*ab (to be referred to as a chroma difference ΔC hereinafter) between a color (L1, a1, b1) and a color (L2, a2, b2) is given by equation (16) above.

When the color conversion table that places importance on the tonality of colors and has been stored in advance in the storage medium 113 is applied to the gradation region 602B shown in FIG. 23 in step S202, the printing apparatus 108 outputs smooth gradation that connects the color 703B to the color 704B in FIG. 24. Even if the chroma decreases when the colors 603B and 606B in the gradation region 602B are printed in the colors 703B and 704B, respectively, if gradation that smoothly connects the colors 703B and 704B is printed, the user will not find the print result unnatural. In this embodiment, the distance between the colors 703B and 704B is large such that the colors can be identified as different colors based on the human visual characteristic. In terms of the human visual characteristic, as the distance between the colors at which the colors can be identified as different colors, the color difference ΔE of CIE76 (a standard for a color space adopted by the International Commission on Illumination) is set to 2.0 or more. On the other hand, if the color 603B of the solid region 603B is output in the color 703B, the noticeability when printing the solid region 603B decreases due to a decrease in chroma, as compared with the digital original.

To cope with this, in this embodiment, a color conversion table for correcting a decrease in noticeability by increasing the chroma of the color 703B in a predetermined color space is generated. More specifically, since the noticeability is improved as the chroma increases, correction processing of increasing the chroma is performed within a range that can be reproduced in the color reproduction region in the predetermined output mode of the printing apparatus 108. It is desirable to obtain the same color as that in the color reproduction region 701B of the image data. However, if it is impossible to reproduce the color in the color reproduction region 702B of the printing apparatus 108 like the color 603B of this embodiment, the chroma is increased as much as possible in the color reproduction region 702B. In this embodiment, a color conversion table for mapping the color 603B to a color 707B is generated. As a result, with respect to the solid region 603B, it is possible to implement, in the printing apparatus 108, reproduction of the chroma as high as possible in the color reproduction region 702B of the printing apparatus 108, thereby improving the noticeability of the print result.

The setting, in step S203, of the second region to which the color conversion table for correcting a decrease in noticeability is not applied will be described next with reference to FIGS. 8A and 8B. As indicated by arrows in FIG. 8A, sequential processing is performed for image data of each pixel in line processing. In the processing for each pixel, as shown in FIG. 8B, it is determined whether color information of three peripheral pixels (pixels 801, 802, and 803) of a pixel 800 of interest (a pixel to be processed) is contiguous with the color information of the pixel of interest. In this embodiment, if the color information of each of the three peripheral pixels of the pixel 800 of interest is not identical to the color information of the pixel 800 of interest and the color difference ΔE is not larger than 2.0, the pixel of interest is set as the second region. A pixel that has already been set as the second region may be reset as the second region in the processing for each pixel. In this embodiment, the second region is set using the above-described sequential processing. However, the present disclosure is not limited to this as long as it is possible to set, as image data, a region where the color information continuously changes. With respect to the image data shown in FIG. 23, the gradation region 602B is set as the second region. FIG. 9 shows the second region set in the processing in step S203. That is, a black region (that is, the gradation region 602B) shown in FIG. 9 is set as the second region, and a white region (that is, the region other than the gradation region) is set as the first region. Steps S202 and S203 may be executed simultaneously.

Next, in step S204, the CPU 111 generates color conversion tables for the first region and the second region set in step S203. The color conversion table for the first region set in step S203 is generated based on the following information.
The image data acquired in step S201
The color conversion table stored in advance in the storage medium 113 and used in step S202
The image data obtained in step S202 by performing color conversion using the color conversion table stored in advance in the storage medium 113
The region information set in step S203

As the color conversion table for the second region, a color conversion table that places importance on the tonality, is different from the color conversion table stored in advance in the storage medium 113 and used in step S202, and has been stored in advance in the storage medium 113 is set.

Examples of the color conversion table stored in advance in the storage medium 113 and used in step S202 and the color conversion table that places importance on the tonality and has been stored in advance in the storage medium 113 will now be described with reference to FIGS. 20A to 20D.

FIG. 20A is a view showing the relationship between the color space of a standard display and the color space of the printing apparatus 108. This is generally called color space compression (color mapping). A plurality of color space compression methods exist, and these are selectively used in accordance with the purpose. In FIG. 20A, a WP 2003 and a WP 2004 indicate the brightest colors (white points) in the color reproduction ranges of the standard display and the printing apparatus 108, respectively. In addition, a BP 2005 and a BP 2006 indicate the darkest colors (black points) in the color reproduction ranges of the standard display and the printing apparatus 108, respectively.

FIG. 20B is a view for explaining an example of the color conversion method applied to the region that places importance on the tonality of colors. As indicated by a solid line 2007 in FIG. 20B, the white point and the black point on the standard display are mapped to the white point and the black point on the printing apparatus 108, respectively. The remaining colors are converted such that the correlation relationship with the white point and the black point is maintained. Color conversion is performed by compressing the chroma on the color direction such that a whole color space 2001 of the standard display is fitted in a color reproduction gamut 2002 of the printing apparatus 108. Hence, colors on the color space 2001 of the standard display are converted to the thick line 2007, and colors on the original color reproduction gamut 2002 are converted to a broken line 2008. The color conversion method shown in FIG. 20B is suitable for processing of image data such as a photo containing a lot of colors. In FIG. 20B, color compression is performed for both lightness and chroma almost on the whole color gamut of the standard display.

FIG. 20C is a view for explaining an example of the color conversion method applied to the region that places importance on the noticeability of colors and used in step S202. This is a method of performing color compression not for colors in the color reproduction gamut of the printing apparatus 108 but for colors outside the color reproduction gamut concerning both lightness and chroma, as shown in FIG. 20C. Thick arrows in FIG. 20C represent color compression processing. A plurality of colors included in the thick arrows are expressed as different colors on the standard display but may be the colors at the ends of the arrows after the mapping. Therefore, the chroma does not decrease with respect to the colors in the color reproduction gamut of the printing apparatus 108. On the other hand, a decrease in chroma is minimized with respect to colors outside the color reproduction gamut since the colors are on the gamut surface. The color conversion method shown in FIG. 20D may be applied to the region that places importance on the noticeability of colors. This is a method of mapping only the white point on the standard display to the white point on the printing apparatus 108, and after that, performing color compression not for colors in the color reproduction gamut of the printing apparatus 108 but for colors outside the print color gamut concerning both lightness and chroma, as shown in FIG. 20D. This aims to reproduce the relative color difference between white color and each color in the standard display as the relative color difference between paper white and each color at the time of printing, and is called “relative colorimetric”. Even in this color conversion method, a plurality of colors included in the thick arrows are expressed as different colors on the standard display but are the same colors at the ends of the arrows after the color conversion. As compared with the color conversion method shown in FIG. 20B, with respect to colors in the color reproduction gamut of the printing apparatus 108, lightness decreases but the degree of a decrease in chroma is small.

Next, in step S205, the CPU 111 executes color conversion based on the following information.
The region information set in step S203.
The color conversion table for the first region set in step S204
The color conversion table for the second region set in step S204, which places importance on the tonality of colors and has been stored in advance in the storage medium 113

In this embodiment, for the image data acquired in step S201, with respect to the first region set in step S203, image data after the color conversion is generated by performing calculation using the color conversion table for the first region set in step S204. On the other hand, with respect to the second region set in step S203, image data after the color conversion is generated by performing calculation using the color conversion table that places importance on the tonality of colors, has been set in step S204, and has been stored in advance in the storage medium 113. The generated image data is stored in the RAM 112 or the storage medium 113.

### <Setting of Color Conversion Method (Generation of Color Conversion Table)>

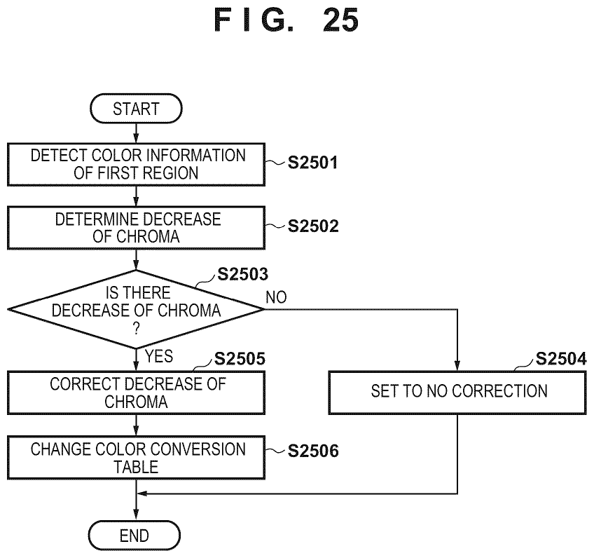

A method of generating, in step S204, a color conversion table for reducing a decrease in chroma, which is set for the first region, will be described in detail with reference to a flowchart shown in FIG. 25. The processing shown in FIG. 25 is implemented when, for example, the CPU 111 executes a program read out to the RAM 112.

In step S2501, the CPU 111 detects the color information of the first region shown in FIG. 9, which has been set in step S203. The detection processing is repeated for each pixel of the image data of the first region, and is executed for all the pixels included in the image data of the first region. In this embodiment, the color 603B shown in FIG. 23 is detected. Note that a color information list is initialized at the start of step S2501.

In step S2502, the CPU 111 detects the number of colors with decreased chroma among colors in the color information list based on the color information list detected in step S2501. In this example, the color 603B is detected as a color with decreased chroma, as described with reference to FIG. 24.

In step S2503, the CPU 111 determines whether the number of colors with decreased chroma in step S2502 is zero. If it is determined that the number of colors with decreased chroma is zero, the process advances to step S2504, and it is determined that it is unnecessary to correct a decrease in chroma for the image data. In this case, as a color conversion table, the color conversion table stored in advance in the storage medium 113 and used in step S202 is set. If it is determined that the number of colors with decreased chroma is not zero, the process advances to step S2505, the CPU 111 corrects a decrease in chroma. In step S2503, if a minimum decrease in chroma occurs due to color conversion to the gamut surface by the color conversion method shown in FIG. 20C, it may be determined that the chroma does not decrease.

Correction of a decrease in chroma changes the colors. Thus, the colors with no decreased chroma are also changed, which is unnecessary. Therefore, based on the number of colors in the color information list and the number of colors with decreased chroma, it may be determined whether it is necessary to correct a decrease in chroma. More specifically, for example, in a case where the majority of all the colors in the color information list are colors with decreased chroma, it may be determined that it is necessary to correct a decrease in chroma (that is, necessity of correction of a decrease in chroma is determined in step S2503). This can suppress adverse effects of a color change caused by correction of a decrease in chroma. For example, FIG. 23 shows the solid region with respect to the color 603B, but assume here that solid regions of 10 colors are shown. In this case, if the number of colors with decreased chroma is, for example, 5 or more, it may be determined that color degeneration correction is necessary.

In step S2505, based on the image data, the image data having undergone the color conversion, and the color conversion table, the CPU 111 corrects a decrease in chroma for the colors with decreased chroma. As described with reference to FIG. 24, the chroma 706B of the color 703B is corrected to chroma 708B of the color 707B within a range that can be reproduced in the color reproduction region in the predetermined output mode of the printing apparatus 108. The correction processing of a decrease in chroma is repeated the number of times that is equal to the number of colors with decreased chroma. Results of correcting a decrease in chroma, the number of which is equal to the number of colors, are held in a table in which color information before correction is associated with color information after correction. In FIG. 24, the color information is color information in the CIE-L*a*b* color space. Therefore, the input image data may be converted into the color space of the output image data. In this case, the results are held in a table in which color information before correction in the color space of the input image data is associated with color information after correction in the color space of the output image data.

In FIG. 24, the color 707B is set to a color with chroma as high as possible in the color reproduction region 702B on a line that connects the colors 703B and 603B but this embodiment is not limited to this. As long as the color can be set to a color with chroma as high as possible in the color reproduction region 702B, which is close to the color 603B of the original data, the direction can be any of the lightness direction, the chroma direction, and the hue angle direction in the CIE-L*a*b* color space.

In step S2506, the CPU 111 changes the color conversion table using the result of correcting a decrease in chroma in step S2505 (corrects a decrease in chroma). The color conversion table before the change is a table for converting the color 603B in FIG. 23 into the color 703B. By using the result of step S2505, the table is changed to a color conversion table for converting the color 603B in FIG. 23 into the color 707B (setting of the color conversion method). On the other hand, if it is determined in step S2503 that it is unnecessary to correct a decrease in chroma, the processing in step S2506 is not performed. In other words, the processing in step S2503 is processing of determining whether to change the color conversion table in step S2506. As described above, the color conversion table for correcting a decrease in chroma can be generated. The color conversion table is repeatedly changed the number of times that is equal to the number of colors with decreased chroma.

### <Print Result>

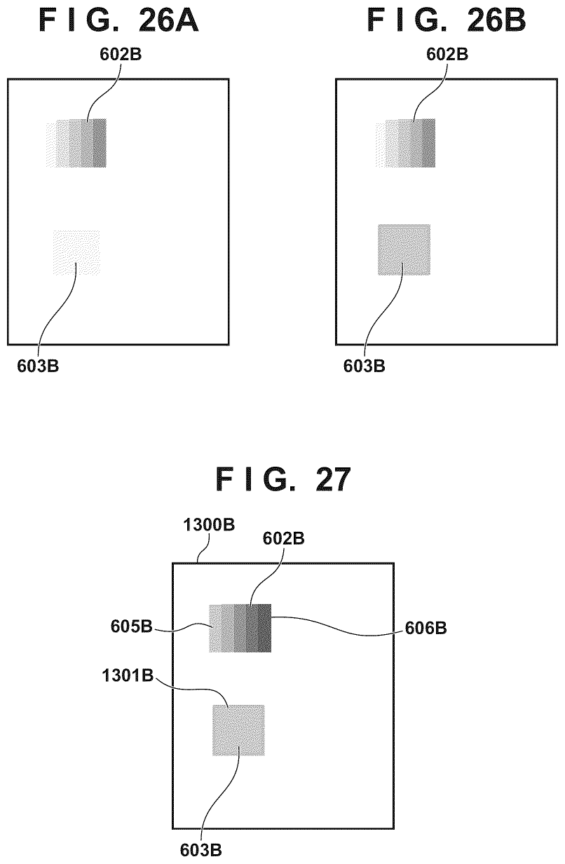

FIGS. 26A and 26B are views each showing an image of a print result according to this embodiment. FIG. 26A shows a print result obtained by performing color conversion for partial original data shown in FIG. 23 by the color conversion table stored in advance in the storage medium 113 and used in step S202, and FIG. 26B shows a print result obtained by performing color conversion according to this embodiment. In both FIGS. 26A and 26B, since the gradation region 602B undergoes color conversion by the color conversion table that places importance on the tonality of colors and has been stored in advance in the storage medium 113, the thus obtained print result is the same, and smooth gradation is reproduced. On the other hand, if the solid region 603B undergoes color conversion by the color conversion table stored in advance in the storage medium 113, a print result with reduced noticeability is obtained due to a decrease in chroma, as shown in FIG. 26A. In this embodiment, by applying the color conversion table corrected in step S2505 to the solid region 603B, it is possible to obtain a print result with improved noticeability closer to that of the digital original as the partial original data, as shown in FIG. 26B.

In the print result shown in FIG. 26B, the chroma calculated from a colorimetric value obtained by performing colorimetry at the position of the solid region 603B is higher than the chroma calculated from a colorimetric value obtained by performing colorimetry at the position of the color 603B at the left end 605B of the gradation region 602B.

According to this embodiment, the first region that places importance on the noticeability of colors and the second region different from the first region are set in image data including no type information. The second region is, for example, a gradation region that places importance on the tonality of colors. Then, by not applying, to the second region, the color conversion method generated from the first region, color conversion that can implement the noticeability and the tonality is executed. As a result, it is possible to obtain a preferable print result with noticeability close to that reproduced in the digital original by improving the noticeability in the print result in the predetermined output mode of the printing apparatus 108, while maintaining the tonality of the gradation region.

In this embodiment, the color conversion table that places importance on the tonality of colors and has been stored in advance in the storage medium 113 is applied to the second region. However, if the color conversion table stored in advance in the storage medium 113 and used in step S202 is applicable, it may be applied to the second region.

This embodiment has explained an example of generating a color conversion table to be applied to the first region. However, the above-described color conversion table that satisfies the noticeability of the print result and has been stored in advance in the storage medium 113 may be applied. As a result, it is possible to reduce the processing time for generating a color conversion table.

Furthermore, in this embodiment, the color conversion table stored in advance in the storage medium 113 is used to set a color conversion table, and a color conversion table is created in the same format as that of the color conversion table. However, for example, color conversion in step S202 may be performed by a predetermined rule such that color is relatively converted from the color reproduction region of the acquired image data into the color reproduction region of the printing apparatus 108 without using the color conversion table stored in the storage medium 113. As a result, it is unnecessary to hold in advance the color conversion table in the storage medium 113, and it is possible to reduce a storage capacity. In the setting of the color conversion method in step S204, without setting the color conversion table, pieces of color information before and after color conversion may be set in one-to-one correspondence with each other (so-called dictionary form), or a formula may be set in a case where approximation can be performed using the formula. As a result, it is possible to reduce a storage capacity for holding the color conversion method, as compared with the color conversion table.

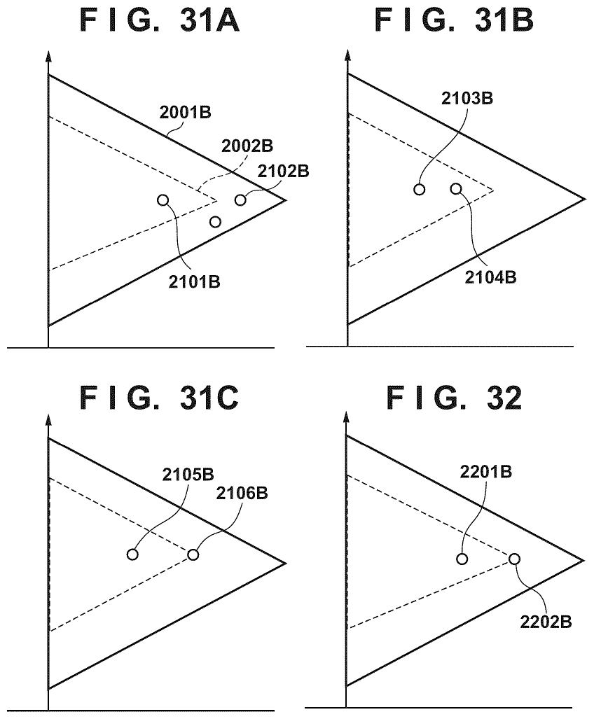

A case where the same effect can be obtained even if the color conversion table used for the first region and the color conversion table used for the second region in step S204 are the same will be described below with reference to FIGS. 31A to 31C. FIG. 31A is a view showing the relationship among a color space 2001B of the standard display, a color space 2002B of the printing apparatus 108, and colors 2101B and 2102B. The color 2101B is a color existing in the color space 2002B, and the color 2102B is a color existing in the color space 2001B. Next, FIG. 31B shows a result of performing color conversion for the colors 2101B and 2102B by the color conversion table used in step S204. This example shows an example in which the color conversion table that places importance on the tonality, as shown in FIG. 20B, is used. However, the present disclosure is not limited to this, and any color conversion table that has a different feature may be used as long as no problem arises by applying the color conversion table to the second region. The colors 2101B and 2102B are converted into colors 2103B and 2104B, respectively, by gamut mapping, and as a result of color conversion, the chroma decreases. FIG. 31C shows a result of performing correction of improving the chroma for the colors 2103B and 2104B. As a result of correction, the colors 2101B and 2102B are finally converted into colors 2105B and 2106B, respectively. In a case where the colors 2101B and 2102B exist in the first region and the second region, these colors are converted into the colors 2105B and 2106B, respectively, in the first region, and are converted into the colors 2103B and 2104B, respectively, in the second region. As a result, it is possible to improve the noticeability of the print result by performing correction of improving the chroma in the first region that places importance on the noticeability while maintaining the tonality of colors in the second region that places importance on the tonality.

A case where the effect of improving the noticeability is obtained by making the color conversion tables used for the first region and the second region different from each other (switching between them) in step S204 without performing correction of improving the chroma shown in FIG. 25 will be described. Such case corresponds to, for example, a case where it is determined in step S2503 that the chroma does not decrease and the process advances to step S2504. An example in a case where the color conversion method, shown in FIG. 20C, that places importance on the noticeability is used for the first region and the color conversion method, shown in FIG. 20B, that places importance on the tonality is used for the second region will be described with reference to FIG. 32. FIG. 32 is a view showing a result of performing color conversion for the colors 2101B and 2102B in FIG. 31A using the color conversion method, shown in FIG. 20C, that places importance on the discriminability. The colors 2101B and 2102B are converted into colors 2201B and 2202B, respectively, by gamut mapping. With respect to the colors 2101B and 2102B, the chroma decreases in the colors 2103B and 2104B, but a decrease in chroma is minimized in the colors 2201B and 2202B. That is, by switching the color conversion table, the effect of improving the noticeability of the print result is obtained.

### Fourth Embodiment

The fourth embodiment will be described below concerning points different from the first to third embodiments. In the third embodiment, the first region that places importance on the noticeability of colors and the second region that places importance on the tonality of colors are set in the image data including no type information. An arrangement for executing color conversion that can implement the noticeability and the tonality by not applying, to the second region that places importance on the tonality of colors, the color conversion method generated from the first region has been explained. However, if the color conversion method is set using all the colors of the first region that places importance on the noticeability of colors, it may be impossible to generate a color conversion table that ensures sufficient noticeability.

FIG. 12 is a flowchart for explaining color conversion processing in step S103 of FIG. 3 according to the fourth embodiment. The processing shown in FIG. 12 is implemented when, for example, a CPU 111 executes a program read out to a RAM 112. Steps S201 to S203 are the same as in the first embodiment and a description thereof will be omitted. Steps S202 and S1201 and step S203 are executed simultaneously. Furthermore, successive processing may be performed in the order of steps S201, S203, and S202.

In step S1201, the CPU 111 sets, on an image represented by image data acquired in step S201, a third region to be used to set a color conversion method of the image data and a fourth region not to be used to set the color conversion method of the image data (region setting). In this embodiment, the setting of the color conversion method is generation of a color conversion table of gamut mapping. In the setting of the color conversion method, a conversion formula may be generated or a color conversion table may be generated. Any method may be adopted as long as it is possible to set a method capable of executing color conversion.

FIG. 27 shows an example of the image data acquired in step S201 according to this embodiment. FIG. 27 shows an example in which a border is unintentionally generated around a solid region 603B shown in FIG. 23 when editing image data of the solid region 603B on a PC 101 using an image editing application or the like. That is, FIG. 27 shows an example of data obtained by editing only the image data of the solid region. As shown in FIG. 27, in this embodiment, a one-pixel color region 1301B surrounding the solid region is generated around the solid region 603B. The color of the color region 1301B will also be referred to as the color 1301B hereinafter. In FIG. 23, there is only the color 603B as the color of the solid region, but in FIG. 27, the color 1301B is generated by the above-described image editing in addition to the color 603B. The color 1301B of the color region 1301B, which is generated without user's intention, is a color separated by a color difference ΔE of 2.0 or more, unlike a gradation region. In this embodiment, the one-pixel color region surrounding the solid region is shown. However, a one- or more-pixel color region surrounding the solid region may be used as long as it is not determined as the gradation region exemplified in the first embodiment.

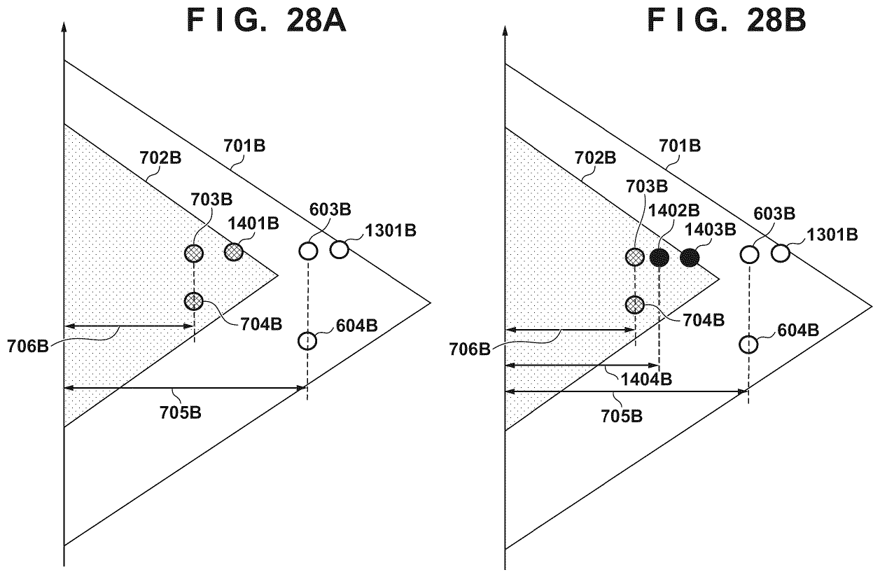

FIGS. 28A and 28B are views for explaining a decrease in chroma and its improvement (resolution) according to this embodiment. In FIGS. 28A and 28B, a color 1401B is a color obtained after performing color conversion for the color 1301B by gamut mapping. By correcting a decrease in chroma as described above, a color conversion table for performing gamut mapping of the colors 603B and 1301B to colors 1402B and 1403B, respectively, is generated. Therefore, although the color 603B undergoes gamut mapping to the color 1402B to obtain high chroma 1404B, it may be impossible to perform color conversion into high chroma like the chroma 708B of the color 707B in the first embodiment. As a result, in a case where the color reproduction region in a predetermined output mode of a printing apparatus is very narrow, the noticeability of the solid region 603B of the print result may be lower than that of the digital original.

To cope with this, in this embodiment, instead of setting a color conversion method using color information of all pixels in the first region according to the first embodiment, the third region to be used to set the color conversion method of input image data and the fourth region not to be used to set the color conversion method of the input image data are set and a color conversion method is set using the color information of the third region. As will be described later, in this embodiment, the third region is set from the input image data, and a color conversion table is generated only for the color information of the third region. As a result, even if the image data shown in FIG. 28A is input, the color conversion method shown not in FIG. 28B but in FIG. 24 can be set, and it is possible to improve the noticeability in an output of a printing apparatus 108.

In this embodiment, color information of image data that can be identified by a person and requires noticeability in the output of the printing apparatus 108 indicates a region planarly having an area equal to or larger than a predetermined area, and this region is set as the third region. Therefore, a region where two or more pixels having the same color information continue in each of the vertical direction and the horizontal direction in the image data is set as the third region. The setting of the third region according to this embodiment will be described with reference to FIGS. 8A and 8B. As indicated by arrows in FIG. 8A, in this embodiment, sequential processing is performed for image data of each pixel in line processing. In the processing for each pixel, as shown in FIG. 8B, it is determined whether color information of three peripheral pixels (pixels 801, 802, and 803) of a pixel 800 to be processed (pixel of interest) is identical to the color information of the pixel of interest. If the determination result indicates that the pieces of color information are identical to each other, the four pixels including the pixel of interest are set as the third region. A pixel that has already been set as the third region may be reset as the third region in the processing for each pixel. In this embodiment, the third region is set using the above-described method. However, the present disclosure is not limited to this as long as it is possible to set a region having the same color information and planarly having an area equal to or larger than a predetermined area. In this embodiment, the region having the same color information is set. However, the same color information in the original image data may vary within a predetermined range in, for example, image data having undergone lossy compression such as JPEG data. To cope with this, an allowable range of variations may be set by, for example, setting the color difference ΔE to 1.0 or less or setting the difference in RGB values to a predetermined value or less with respect to the region having the same color information.

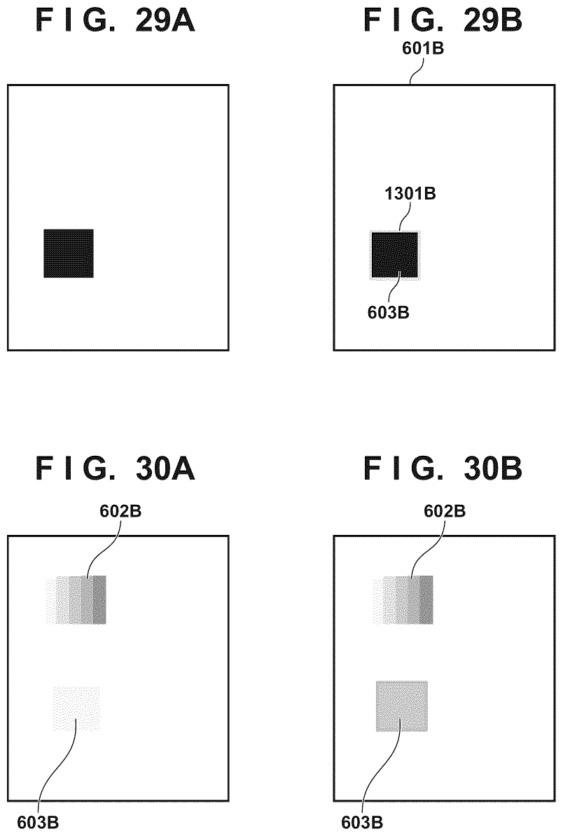

As a result of the setting, in this embodiment, with respect to any of the image data shown in FIGS. 23 and 27, a black region shown in FIG. 29A is set as the third region and a white region shown in FIG. 29A is set as the fourth region. In other words, even if the color 1301B unintended by the user is generated, the color is not considered when setting the color conversion method of the input image data.

As shown in FIGS. 29A and 29B, in this embodiment, as color information of image data that can be identified by a person and requires noticeability in the output of the printing apparatus 108, the color 603B of the solid region planarly having an area equal to or larger than a predetermined area is set. As shown in FIG. 29B, the color 1301B is a color not in the third region to be used to generate a color conversion table after correction of a decrease in chroma (to be used to set a color conversion method) but in the fourth region adjacent to the third region. As described above, the color 1301B is converted by the color conversion table after correction of a decrease in chroma. In other words, a region to which the color conversion table after correction of a decrease in chroma is applied can be a region including the third region and at least a part of the fourth region. As described above, by making the region to be used to generate a color conversion table after correction of a decrease in chroma different from the region to which the generated color conversion table after correction of a decrease in chroma is applied, it is possible to prevent unnecessary correction of a decrease in chroma, and obtain an optimum output image.

FIG. 16B shows a first region to which a color conversion table that places importance on the noticeability of colors is applied and that has been set in step S203 and a second region to which the color conversion table that places importance on the noticeability of colors is not applied and that has been set in step S203. In FIG. 16B, the second region is shown as a black region, and the first region is shown as a white region. As shown in FIGS. 16A and 16B, a condition for setting the first region and the second region and a condition for setting the third region and the fourth region are desirably set so that the first region applicable with the color conversion method that places importance on the noticeability of colors includes the third region to be used to set the color conversion method that places importance on the noticeability of colors. That is, setting is desirably performed so the third region to be used to set the color conversion method that places importance on the noticeability of colors is not set as the fourth region to which the color conversion method that places importance on the noticeability of colors is not applied.

Next, in step S1202, the CPU 111 generates, based on the following information, a color conversion table for the first region set in step S203.
The image data acquired in step S201
The color conversion table stored in advance in a storage medium 113 and used in step S202
The image data obtained by performing color conversion using the color conversion table stored in advance in the storage medium 113 in step S202
The region information set in step S1201

Although the color conversion method is set using the region information set in step S1201, the setting of the color conversion method is the same as in the first embodiment and a description thereof will be omitted. As the color conversion table for the second region, a color conversion table that places importance on the tonality of colors and has been stored in advance in the storage medium 113 is set.

Next, in step S1203, the CPU 111 executes color conversion based on the following information.
The region information set in step S203
The color conversion table for the first region set in step S1202
The color conversion table for the second region set in step S203, which places importance on the tonality of colors and has been stored in advance in the storage medium 113

For the image data acquired in step S201, with respect to the first region set in step S203, image data after the color conversion is generated by performing calculation using the color conversion table for the first region set in step S1202. On the other hand, with respect to the second region set in step S203, image data after the color conversion is generated by performing calculation using the color conversion table that places importance on the tonality of colors, has been set in step S1202, and has been stored in advance in the storage medium 113. The generated image data is stored in the RAM 112 or the storage medium 113.

### <Print Result>

FIGS. 30A and 30B are views each showing an image of a print result according to this embodiment. FIG. 30A shows a print result obtained by performing color conversion for the partial original data shown in FIG. 27 by the color conversion table stored in advance in the storage medium 113 and used in step S202, and FIG. 30B shows a print result obtained by performing color conversion according to this embodiment. In both FIGS. 30A and 30B, since a gradation region 602B undergoes color conversion by the color conversion table that places importance on the tonality of colors and has been stored in advance in the storage medium 113, the thus obtained print result is the same, and smooth gradation is reproduced. On the other hand, similar to the first embodiment, if the solid region 603B undergoes color conversion by the color conversion table stored in advance in the storage medium 113, a print result with reduced noticeability is obtained due to a decrease in chroma, as shown in FIG. 30A. In this embodiment, when the color conversion table set in step S1202 is applied, even if the color 1301B unintended by the user is generated around the solid region 603B, it is possible to obtain a print result with noticeability close to that of the digital original within a range that can be reproduced in the color reproduction region in the predetermined output mode of the printing apparatus 108 with respect to the solid region, as shown in FIG. 30B.

In the print result shown in FIG. 30B, the chroma defined by CIE76 and calculated from a colorimetric value obtained by performing colorimetry at the position of the solid region 603B is higher than the chroma calculated from a colorimetric value obtained by performing colorimetry at the position of the color 603B at a left end 605B of the gradation region 602B.

In a case where the image data shown in FIG. 23 is input as next partial original data of the image data shown in FIG. 27, a print result of the next page is as shown in FIG. 26B. In the print result obtained by the processing of this embodiment, even if the color 1301B different from that in FIG. 27 and unintended by the user is generated around the solid region 603B, the print result of the solid region 603B includes completely the same color as a colorimetric result. That is, in the processing of this embodiment, even if the color 1301B unintended by the user is generated, it is possible to ensure the noticeability of the solid region 603B. In addition, if the color value extracted in the third region is the same between pages, the print result of the solid region is the same between the pages.

According to this embodiment, the first region that places importance on the noticeability of colors and the second region different from the first region are set in the image data including no type information. The second region is, for example, a gradation region that places importance on the tonality of colors. In addition, the third region to be used to set a color conversion method of the image data and the fourth region not to be used to set the color conversion method of the image data are set. By setting the respective regions, it is possible to prevent unnecessary correction of a decrease in chroma and set an appropriate color conversion method based on only information of the region (that is, the third region) necessary for correction of a decrease in chroma. As a result, it is possible to obtain a color conversion result preferable for the printing apparatus 108 with respect to the entire image.

In this embodiment, with respect to color information of image data that can be identified by a person and places importance on noticeability in the output of the printing apparatus 108, the third region is set as a region planarly having a predetermined area under the condition that two or more pixels having the same color information continue in each of the vertical direction and the horizontal direction. However, the number of pixels continuing in each of the vertical and horizontal directions may be set in accordance with the output resolution of the printing apparatus 108 and the visual characteristic and the like of a person who observes an output product of the printing apparatus 108. As a result, it is possible to set the third region more optimally. Alternatively, the user who uses the printing apparatus 108 may designate the setting condition of the third region using the user interface (UI) of the printing apparatus 108 or attribute information of the original data. As a result, it is possible to reflect the user's intention in the setting condition of the third region.

This embodiment has explained an example of avoiding degradation in image quality by setting, as the second region, a region whose image quality degrades by applying the color conversion method generated from the third region to the image data and not applying the color conversion method generated from the third region to the second region. However, the first region and the second region may be separated by setting the first region whose image quality does not degrade even by applying the color conversion method generated from the third region to the image data.

In each embodiment, the user may be able to input an instruction of whether to execute correction of a decrease in chroma. In this case, a UI screen shown in FIG. 18 or 19 may be displayed on the UI 103 of the PC 101 or a display unit (not shown) mounted on the printing apparatus 108, thereby making it possible to accept a user instruction. On the UI screen shown in FIG. 18, it is possible to prompt the user to select a color correction type by a toggle button. Furthermore, it is possible to prompt the user to select, by a toggle button, ON/OFF of whether to execute “adaptive gamut mapping” indicating the processing described in each embodiment. On the UI screen shown in FIG. 19, it is possible to automatically execute the processing in accordance with selection, by a medium selection toggle button, of ON/OFF of whether to execute “adaptive gamut mapping” indicating the processing described in each embodiment. If plain paper is selected as a print medium, as shown in FIG. 19, the color reproduction region is narrow, and thus “adaptive gamut mapping” is executed. Alternatively, if glossy paper or coated paper is selected, the color reproduction region is wide, and thus “adaptive gamut mapping” is not executed.

With this arrangement, it is possible to switch, in accordance with the user instruction, whether to execute adaptive gamut mapping indicating the processing described in each embodiment. As a result, when the user wants to reduce the degree of a decrease in chroma, gamut mapping described in each embodiment can be executed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefits of Japanese Patent Application No. 2024-231017, filed Dec. 26, 2024, and Japanese Patent Application No. 2024-231018, filed Dec. 26, 2024, that are hereby incorporated by reference herein in their entirety.

What is claimed is:

1. An image processing apparatus comprising:
an input unit configured to input image data; and
a first color conversion unit configured to execute, in a case where an image represented by the image data input by the input unit includes a gradation region including gradation between a first color value and a second color value and a region other than the gradation region in the image includes a first solid region with only the first color value and a second solid region with only the second color value, color conversion for the first solid region and the second solid region by a first color conversion method and color conversion for the gradation region by a second color conversion method,
wherein the color conversion by the first color conversion unit is conversion from a color gamut represented by the image data into a color gamut that can be reproduced by the image processing apparatus, and
as a result of executing the color conversion by the first color conversion unit, a color difference between the first solid region and the second solid region is larger than a color difference between a region corresponding to the first color value and a region corresponding to the second color value in the gradation region.

2. The apparatus according to claim 1, further comprising a first detection unit configured to detect the gradation region.

3. The apparatus according to claim 2, wherein the first color conversion unit executes, by the first color conversion method, the color conversion for a region other than the gradation region detected by the first detection unit.

4. The apparatus according to claim 2, further comprising a setting unit configured to set the first color conversion method,
wherein the setting unit sets the first color conversion method based on the first color value of the first solid region and the second color value of the second solid region.

5. The apparatus according to claim 4, further comprising:
a storage unit configured to store a predetermined color conversion method; and
a second color conversion unit configured to execute color conversion for a region other than the gradation region by the predetermined color conversion method,
wherein in a case where as a result of executing the color conversion by the second color conversion unit, such color degeneration that a color difference between a color value obtained after the color conversion of the first color value and a color value obtained after the color conversion of the second color value decreases has occurred, the setting unit sets the first color conversion method by correcting the predetermined color conversion method so as to resolve the color degeneration.

6. The apparatus according to claim 5, wherein in a case where as a result of executing the color conversion by the second color conversion unit, the color degeneration has not occurred, the setting unit sets the predetermined color conversion method as the first color conversion method.

7. The apparatus according to claim 5, wherein the setting unit corrects the predetermined color conversion method so that the color difference becomes at least a predetermined value.

8. The apparatus according to claim 7, wherein the predetermined value is ΔE=2.0.

9. The apparatus according to claim 5, wherein the setting unit corrects the predetermined color conversion method so as to resolve the color difference in at least one of a lightness direction, a chroma direction, and a hue angle direction.

10. The apparatus according to claim 4, wherein
in a case where a region other than the gradation region includes a third solid region with only the first color value and a fourth solid region with only the second color value, a first color region with a third color value exists around the third solid region, and a second color region with a fourth color value exists around the fourth solid region,
as a result of executing the color conversion by the first color conversion unit, a color value of the first solid region is equal to a color value of the third solid region, and a color value of the second solid region is equal to a color value of the fourth solid region.

11. The apparatus according to claim 10, further comprising a second detection unit configured to detect the third solid region and the fourth solid region.

12. The apparatus according to claim 10, wherein the setting unit sets the first color conversion method based on the first color value of the third solid region and the second color value of the fourth solid region, and does not set the first color conversion method based on the third color value of the first color region and the fourth color value of the second color region.

13. The apparatus according to claim 1, wherein the first color conversion method and the second color conversion method are different from each other.

14. The apparatus according to claim 13, wherein the first color conversion method is a color conversion method of performing no compression within a color gamut that can be reproduced by the image processing apparatus, and the second color conversion method is a color conversion method of performing compression within the color gamut that can be reproduced by the image processing apparatus.

15. The apparatus according to claim 1, further comprising an acceptance unit configured to accept an instruction of whether to execute the color conversion by the first color conversion unit,
wherein the color conversion by the first color conversion unit is executed in a case where the acceptance unit accepts the instruction to execute the color conversion by the first color conversion unit.

16. The apparatus according to claim 15, wherein the acceptance unit accepts selection of a predetermined type of print medium as the instruction to execute the color conversion by the first color conversion unit.

17. The apparatus according to claim 16, wherein the predetermined type of print medium is plain paper.

18. The apparatus according to claim 1, wherein the image processing apparatus is an inkjet printing apparatus.

19. The apparatus according to claim 1, wherein the image data is bitmap image data including no pixel-based type information.

20. A method executed in an image processing apparatus, comprising:
inputting image data; and
executing, in a case where an image represented by the input image data includes a gradation region including gradation between a first color value and a second color value and a region other than the gradation region in the image includes a first solid region with only the first color value and a second solid region with only the second color value, color conversion for the first solid region and the second solid region by a first color conversion method and color conversion for the gradation region by a second color conversion method,
wherein the color conversion is conversion from a color gamut represented by the image data into a color gamut that can be reproduced by the image processing apparatus, and
as a result of executing the color conversion, a color difference between the first solid region and the second solid region is larger than a color difference between a region corresponding to the first color value and a region corresponding to the second color value in the gradation region.

21. An image processing apparatus comprising:
an input unit configured to input image data; and
a first color conversion unit configured to execute, in a case where an image represented by the image data input by the input unit includes a gradation region including gradation between a first color value and a second color value and a region other than the gradation region in the image includes a first solid region with only the first color value, color conversion for the first solid region by a first color conversion method and color conversion for the gradation region by a second color conversion method,
wherein the color conversion by the first color conversion unit is conversion from a color gamut represented by the image data into a color gamut that can be reproduced by the image processing apparatus, and
as a result of executing the color conversion by the first color conversion unit, chroma obtained after the color conversion of the first solid region is higher than chroma obtained after the color conversion of a region corresponding to the first color value in the gradation region.

22. The apparatus according to claim 21, further comprising a first detection unit configured to detect the gradation region.

23. The apparatus according to claim 21, further comprising a setting unit configured to set the first color conversion method,
wherein the setting unit sets the first color conversion method based on the first color value of the first solid region.

24. The apparatus according to claim 23, further comprising:
a storage unit configured to store a predetermined color conversion method; and
a second color conversion unit configured to execute color conversion by the predetermined color conversion method,
wherein as a result of executing the color conversion by the second color conversion unit, the setting unit sets the first color conversion method based on the first color value of the first solid region and a color value obtained after the color conversion of the first color value of the first solid region.

25. The apparatus according to claim 24, wherein in a case where as a result of executing the color conversion by the second color conversion unit, chroma represented by the color value obtained after the color conversion is lower than chroma represented by the first color value, the setting unit sets the first color conversion method by correcting the predetermined color conversion method so as to increase the chroma represented by the color value obtained after the color conversion.

26. The apparatus according to claim 25, wherein in a case where as a result of executing the color conversion by the second color conversion unit, the chroma represented by the color value obtained after the color conversion is not lower than the chroma represented by the first color value, the setting unit sets the predetermined color conversion method as the first color conversion method.

27. The apparatus according to claim 25, wherein the setting unit corrects the predetermined color conversion method so as to increase the chroma represented by the color value obtained after the color conversion in at least one of a lightness direction and a hue angle direction.

28. The apparatus according to claim 24, wherein
in a case where a region other than the gradation region includes a second solid region with only the first color value and a first color region with a third color value exists around the second solid region,
as a result of executing the color conversion by the first color conversion unit, the chroma obtained after the color conversion of the first solid region is equal to chroma obtained after the color conversion of the second solid region.

29. The apparatus according to claim 28, further comprising a second detection unit configured to detect the second solid region.

30. The apparatus according to claim 28, wherein the setting unit sets the first color conversion method based on the first color value of the second solid region and the color value obtained after the color conversion of the first color value of the second solid region by the second color conversion unit, and does not set the first color conversion method based on the third color value of the first color region.

31. The apparatus according to claim 21, wherein the first color conversion method and the second color conversion method are different from each other.

32. The apparatus according to claim 31, wherein the first color conversion method is a color conversion method of performing no compression within a color gamut that can be reproduced by the image processing apparatus, and the second color conversion method is a color conversion method of performing compression within the color gamut that can be reproduced by the image processing apparatus.

33. The apparatus according to claim 21, further comprising an acceptance unit configured to accept an instruction of whether to execute the color conversion by the first color conversion unit,
wherein the color conversion by the first color conversion unit is executed in a case where the acceptance unit accepts the instruction to execute the color conversion by the first color conversion unit.

34. The apparatus according to claim 33, wherein the acceptance unit accepts selection of a predetermined type of print medium as the instruction to execute the color conversion by the first color conversion unit.

35. The apparatus according to claim 34, wherein the predetermined type of print medium is plain paper.

36. The apparatus according to claim 21, wherein the image processing apparatus is an inkjet printing apparatus.

37. A method executed in an image processing apparatus, comprising:
inputting image data; and
executing, in a case where an image represented by the input image data includes a gradation region including gradation between a first color value and a second color value and a region other than the gradation region in the image includes a first solid region with only the first color value, color conversion for the first solid region by a first color conversion method and color conversion for the gradation region by a second color conversion method,
wherein the color conversion is conversion from a color gamut represented by the image data into a color gamut that can be reproduced by the image processing apparatus, and
as a result of executing the color conversion, chroma obtained after the color conversion of the first solid region is higher than chroma obtained after the color conversion of a region corresponding to the first color value in the gradation region.
